(19) United States
(12) Patent Application Publication
(10) Pub. No.: US 2025/0176064 A1
(43) Pub. Date: May 29, 2025

(54) ADAPTIVELY RESTRICTING COMMUNICATION FOR CELL DISCONTINUOUS OPERATION

(71) Applicant: QUALCOMM Incorporated, San Diego, CA (US)

(72) Inventors: Ahmed Attia ABOTABL, San Diego, CA (US); Marwen ZORGUI, San Diego, CA (US); Diana MAAMARI, San Diego, CA (US); Sherif ELAZZOUNI, San Diego, CA (US); Irmak AYKIN, Escondido, CA (US)

(21) Appl. No.: 18/523,218

(22) Filed: Nov. 29, 2023

(51) Int. Cl. H04W 76/28; H04W 52/02; H04W 72/232

(52) U.S. Cl. CPC H04W 76/28; H04W 52/0235; H04W 72/232

(57) ABSTRACT

Methods, systems, and devices for wireless communication are described. A user equipment (UE) may receive first control messages indicating multiple cell discontinuous transmission (DTX) or discontinuous reception (DRX) (DTX/DRX) configurations associated with a serving cell, each cell DTX/DRX configuration of the multiple cell DTX/DRX configurations being associated with a respective DTX/DRX cycle. The UE may receive second control messages indicating multiple signaling restriction sets, each signaling restriction set being associated with one or more cell DTX/DRX configurations, and each signaling restriction set including one or more respective signaling restrictions associated with communication between the UE and the serving cell over a non-active period of the respective DTX/DRX cycle. The UE may communicate with the serving cell in accordance with a cell DTX/DRX configuration and a signaling restriction set associated with the cell DTX/DRX configuration.

### TECHNICAL FIELD

The following relates to wireless communication, including adaptively restricting communication for cell discontinuous operations.

### DESCRIPTION OF THE RELATED TECHNOLOGY

Wireless communication systems are widely deployed to provide various types of communication content such as voice, video, packet data, messaging, broadcast, and so on. These systems may be capable of supporting communication with multiple users by sharing the available system resources (such as time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communication system may include one or more base stations, each supporting wireless communication for communication devices, which may be known as user equipment (UE).

A cell of a network may perform or otherwise communicate in accordance with discontinuous operation, such as discontinuous reception (DRX) and/or discontinuous transmission (DTX). In some cases, the cell may perform or communicate in accordance with the discontinuous operation for network energy savings (NES). For example, the discontinuous operation may be associated with a cycle of active periods and non-active periods and a network entity associated with (such as operating, supporting, or otherwise communicating via) the cell may receive and/or transmit signaling during the active periods and may refrain (at least in part) from receiving and/or transmitting during the non-active periods. Likewise, a UE that communicates with the network entity via the cell may receive an indication of the discontinuous operation (which may be understood as a cell discontinuous operation) and may communicate with the network entity in accordance with the cycle of active periods and non-active periods.

### SUMMARY

The systems, methods and devices of this disclosure each have several innovative aspects, no single one of which is solely responsible for the desirable attributes disclosed herein.

One innovative aspect of the subject matter described in this disclosure can be implemented in a user equipment (UE). The UE may include a processing system that includes processor circuitry and memory circuitry that stores code. The processing system configured to cause the UE to receive one or more first control messages including information indicative of a set of multiple cell discontinuous transmission (DTX) or discontinuous reception (DRX) (DTX/DRX) configurations associated with a serving cell, each cell DTX/DRX configuration of the set of multiple cell DTX/DRX configurations being associated with a respective DTX/DRX cycle, receive one or more second control messages including information indicative of a set of multiple signaling restriction sets, each signaling restriction set of the set of multiple signaling restriction sets being associated with one or more cell DTX/DRX configurations of the set of multiple cell DTX/DRX configurations, each signaling restriction set of the set of multiple signaling restriction sets including one or more respective signaling restrictions associated with communication between the UE and the serving cell over one or more non-active periods of the respective DTX/DRX cycle, and communicate with the serving cell in accordance with a cell DTX/DRX configuration of the set of multiple cell DTX/DRX configurations and in accordance with a signaling restriction set of the set of multiple signaling restriction sets that is associated with the cell DTX/DRX configuration.

Another innovative aspect of the subject matter described in this disclosure can be implemented in a method for wireless communication by a UE. The method may include receiving one or more first control messages including information indicative of a set of multiple cell DTX/DRX configurations associated with a serving cell, each cell DTX/DRX configuration of the set of multiple cell DTX/DRX configurations being associated with a respective DTX/DRX cycle, receiving one or more second control messages including information indicative of a set of multiple signaling restriction sets, each signaling restriction set of the set of multiple signaling restriction sets being associated with one or more cell DTX/DRX configurations of the set of multiple cell DTX/DRX configurations, each signaling restriction set of the set of multiple signaling restriction sets including one or more respective signaling restrictions associated with communication between the UE and the serving cell over one or more non-active periods of the respective DTX/DRX cycle, and communicating with the serving cell in accordance with a cell DTX/DRX configuration of the set of multiple cell DTX/DRX configurations and in accordance with a signaling restriction set of the set of multiple signaling restriction sets that is associated with the cell DTX/DRX configuration.

Another innovative aspect of the subject matter described in this disclosure can be implemented in a UE. The UE may include means for receiving one or more first control messages including information indicative of a set of multiple cell DTX/DRX configurations associated with a serving cell, each cell DTX/DRX configuration of the set of multiple cell DTX/DRX configurations being associated with a respective DTX/DRX cycle, means for receiving one or more second control messages including information indicative of a set of multiple signaling restriction sets, each signaling restriction set of the set of multiple signaling restriction sets being associated with one or more cell DTX/DRX configurations of the set of multiple cell DTX/DRX configurations, each signaling restriction set of the set of multiple signaling restriction sets including one or more respective signaling restrictions associated with communication between the UE and the serving cell over one or more non-active periods of the respective DTX/DRX cycle, and means for communicating with the serving cell in accordance with a cell DTX/DRX configuration of the set of multiple cell DTX/DRX configurations and in accordance with a signaling restriction set of the set of multiple signaling restriction sets that is associated with the cell DTX/DRX configuration.

Another innovative aspect of the subject matter described in this disclosure can be implemented in a non-transitory computer-readable medium storing code for wireless communication by a UE. The code may include instructions executable by one or more processors (such as a processing system including one or more processors) to receive one or more first control messages including information indicative of a set of multiple cell DTX/DRX configurations associated with a serving cell, each cell DTX/DRX configuration of the set of multiple cell DTX/DRX configurations being associated with a respective DTX/DRX cycle, receive one or more second control messages including information indicative of a set of multiple signaling restriction sets, each signaling restriction set of the set of multiple signaling restriction sets being associated with one or more cell DTX/DRX configurations of the set of multiple cell DTX/DRX configurations, each signaling restriction set of the set of multiple signaling restriction sets including one or more respective signaling restrictions associated with communication between the UE and the serving cell over one or more non-active periods of the respective DTX/DRX cycle, and communicate with the serving cell in accordance with a cell DTX/DRX configuration of the set of multiple cell DTX/DRX configurations and in accordance with a signaling restriction set of the set of multiple signaling restriction sets that is associated with the cell DTX/DRX configuration.

Some examples of the method, UEs, and non-transitory computer-readable medium described herein may further include operations, features, means, or instructions for receiving an indication of a set of multiple non-active duration thresholds associated with the set of multiple signaling restriction sets and selecting the signaling restriction set in accordance with whether a duration of a non-active period of a DTX/DRX cycle associated with the cell DTX/DRX configuration satisfies one or more of the set of multiple non-active duration thresholds.

In some examples of the method, UEs, and non-transitory computer-readable medium described herein, the first signaling restriction set corresponds to a first subset of cell DTX/DRX configurations of the set of multiple cell DTX/DRX configurations, each cell DTX/DRX configuration of the first subset of cell DTX/DRX configurations being associated with a respective first DTX/DRX cycle including first non-active periods of durations less than or equal to a first non-active duration threshold of the set of multiple non-active duration thresholds, the second signaling restriction set corresponds to a second subset of cell DTX/DRX configurations of the set of multiple cell DTX/DRX configurations, each cell DTX/DRX configuration of the second subset of cell DTX/DRX configurations being associated with a respective second DTX/DRX cycle including non-active periods of durations greater than the first non-active duration threshold and less than or equal to a second non-active duration threshold of the set of multiple non-active duration thresholds, the second signaling restriction set including a smaller quantity of signaling restrictions relative to the first signaling restriction set, and the third signaling restriction set corresponds to a third subset of cell DTX/DRX configurations of the set of multiple cell DTX/DRX configurations, each cell DTX/DRX configuration of the third subset of cell DTX/DRX configurations being associated with a respective third DTX/DRX cycle including third non-active periods of durations greater than the second non-active duration threshold, the third signaling restriction set including a smaller quantity of signaling restrictions relative to the second signaling restriction set.

Another innovative aspect of the subject matter described in this disclosure can be implemented in a network entity. The network entity may include a processing system that includes processor circuitry and memory circuitry that stores code. The processing system configured to cause the network entity to transmit, to a UE, one or more first control messages including information indicative of a set of multiple DTX/DRX configurations associated with a serving cell, each cell DTX/DRX configuration of the set of multiple cell DTX/DRX configurations being associated with a respective DTX/DRX cycle, transmit one or more second control messages including information indicative of a set of multiple signaling restriction sets, each signaling restriction set of the set of multiple signaling restriction sets being associated with one or more cell DTX/DRX configurations of the set of multiple cell DTX/DRX configurations, each signaling restriction set of the set of multiple signaling restriction sets including one or more respective signaling restrictions associated with communication between the UE and the serving cell over one or more non-active periods of the respective DTX/DRX cycle, and communicate with the UE via the serving cell in accordance with a cell DTX/DRX configuration of the set of multiple cell DTX/DRX configurations and in accordance with a signaling restriction set of the set of multiple signaling restriction sets that is associated with the cell DTX/DRX configuration.

Another innovative aspect of the subject matter described in this disclosure can be implemented in a method for wireless communication by a network entity. The method may include transmitting, to a UE, one or more first control messages including information indicative of a set of multiple DTX/DRX configurations associated with a serving cell, each cell DTX/DRX configuration of the set of multiple cell DTX/DRX configurations being associated with a respective DTX/DRX cycle, transmitting one or more second control messages including information indicative of a set of multiple signaling restriction sets, each signaling restriction set of the set of multiple signaling restriction sets being associated with one or more cell DTX/DRX configurations of the set of multiple cell DTX/DRX configurations, each signaling restriction set of the set of multiple signaling restriction sets including one or more respective signaling restrictions associated with communication between the UE and the serving cell over one or more non-active periods of the respective DTX/DRX cycle, and communicating with the UE via the serving cell in accordance with a cell DTX/DRX configuration of the set of multiple cell DTX/DRX configurations and in accordance with a signaling restriction set of the set of multiple signaling restriction sets that is associated with the cell DTX/DRX configuration.

Another innovative aspect of the subject matter described in this disclosure can be implemented in a network entity. The network entity may include means for transmitting, to a UE, one or more first control messages including information indicative of a set of multiple DTX/DRX configurations associated with a serving cell, each cell DTX/DRX configuration of the set of multiple cell DTX/DRX configurations being associated with a respective DTX/DRX cycle, means for transmitting one or more second control messages including information indicative of a set of multiple signaling restriction sets, each signaling restriction set of the set of multiple signaling restriction sets being associated with one or more cell DTX/DRX configurations of the set of multiple cell DTX/DRX configurations, each signaling restriction set of the set of multiple signaling restriction sets including one or more respective signaling restrictions associated with communication between the UE and the serving cell over one or more non-active periods of the respective DTX/DRX cycle, and means for communicating with the UE via the serving cell in accordance with a cell DTX/DRX configuration of the set of multiple cell DTX/DRX configurations and in accordance with a signaling restriction set of the set of multiple signaling restriction sets that is associated with the cell DTX/DRX configuration.

Another innovative aspect of the subject matter described in this disclosure can be implemented in a non-transitory computer-readable medium storing code for wireless communication by a network entity. The code may include instructions executable by one or more processors (such as a processing system including one or more processors) to transmit, to a UE, one or more first control messages including information indicative of a set of multiple DTX/DRX configurations associated with a serving cell, each cell DTX/DRX configuration of the set of multiple cell DTX/DRX configurations being associated with a respective DTX/DRX cycle, transmit one or more second control messages including information indicative of a set of multiple signaling restriction sets, each signaling restriction set of the set of multiple signaling restriction sets being associated with one or more cell DTX/DRX configurations of the set of multiple cell DTX/DRX configurations, each signaling restriction set of the set of multiple signaling restriction sets including one or more respective signaling restrictions associated with communication between the UE and the serving cell over one or more non-active periods of the respective DTX/DRX cycle, and communicate with the UE via the serving cell in accordance with a cell DTX/DRX configuration of the set of multiple cell DTX/DRX configurations and in accordance with a signaling restriction set of the set of multiple signaling restriction sets that is associated with the cell DTX/DRX configuration.

Some examples of the method, network entities, and non-transitory computer-readable medium described herein may further include operations, features, means, or instructions for transmitting an indication of a non-active duration threshold associated with the plurality of signaling restriction sets and selecting the signaling restriction set in accordance with whether a duration of a non-active period of a DTX/DRX cycle associated with the cell DTX/DRX configuration satisfies the non-active duration threshold.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIGS. 1 and 2 show example wireless communication systems that support adaptively restricting communication for cell discontinuous operation in accordance with one or more aspects of the present disclosure.

FIGS. 3A and 3B show example signaling restriction set thresholds that support adaptively restricting communication for cell discontinuous operation in accordance with one or more aspects of the present disclosure.

FIG. 4A shows an example downlink control information (DCI) message that supports adaptively restricting communication for cell discontinuous operation in accordance with one or more aspects of the present disclosure.

FIG. 4B shows an example discontinuous operation cycle that supports adaptively restricting communication for cell discontinuous operation in accordance with one or more aspects of the present disclosure.

FIG. 5 shows an example process flow that supports adaptively restricting communication for cell discontinuous operation in accordance with one or more aspects of the present disclosure.

FIGS. 6 and 7 show block diagrams of example devices that support adaptively restricting communication for cell discontinuous operation in accordance with one or more aspects of the present disclosure.

FIG. 8 shows a block diagram of an example communication manager that supports adaptively restricting communication for cell discontinuous operation in accordance with one or more aspects of the present disclosure.

FIG. 9 shows a diagram of a system including an example device that supports adaptively restricting communication for cell discontinuous operation in accordance with one or more aspects of the present disclosure.

FIGS. 10 and 11 show block diagrams of example devices that support adaptively restricting communication for cell discontinuous operation in accordance with one or more aspects of the present disclosure.

FIG. 12 shows a block diagram of an example communication manager that supports adaptively restricting communication for cell discontinuous operation in accordance with one or more aspects of the present disclosure.

FIG. 13 shows a diagram of a system including an example device that supports adaptively restricting communication for cell discontinuous operation in accordance with one or more aspects of the present disclosure.

FIGS. 14-17 show flowcharts illustrating example methods that support adaptively restricting communication for cell discontinuous operation in accordance with one or more aspects of the present disclosure.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

Various aspects generally relate to discontinuous operation configurations of a serving cell, including cell discontinuous transmission (DTX) configurations and/or cell discontinuous reception (DRX) configurations. Some aspects more specifically relate to how a user equipment (UE) associated with (such as served by) the serving cell may communicate (such as transmit and/or receive) with the serving cell during a non-active period (such as non-active or inactive duration of time) of a cell DTX or DRX (DTX/DRX) configuration in accordance with one or more adaptively selected signaling restrictions. For example, cell DTX/DRX may be associated with a periodic cycle of active periods and non-active periods and the UE may adaptively select signaling restrictions associated with communication with the serving cell during the non-active periods. In some implementations, the UE may receive control signaling, such as radio resource control (RRC) signaling, including information indicative of multiple cell DTX/DRX configurations and multiple signaling restriction sets, each respective signaling restriction set including a respective set of restrictions associated with communication between the UE and the serving cell. In such implementations, the UE may select a signaling restriction set from the multiple signaling restriction sets and communicate, during non-active periods of an activated cell DTX/DRX configuration, in accordance with the selected signaling restriction set. Communication in accordance with a signaling restriction set may be understood as refraining from transmitting and/or receiving one or more specific signals, and/or via one or more specific channels, in accordance with which specific restrictions are included in the signaling restriction set.

The UE may select the signaling restriction set from the multiple signaling restriction sets in accordance with a configured mapping (such as a mapping indicated via the RRC signaling), an indication in an activating downlink control information (DCI) message (which may be understood or referred to as an activation DCI), or some other criteria. Such other criteria may include one or more non-active duration thresholds, one or more active duration thresholds, a latency tolerance of the UE, and/or a power level of the UE. For example, the UE may select a first signaling restriction set including relatively more restrictions in examples in which a non-active period of an activated cell DTX/DRX configuration has a duration that is less than a non-active duration threshold and may select a second signaling restriction set including relatively fewer restrictions in examples in which a duration of a non-active period of an activated cell DTX/DRX configuration is greater than the non-active duration threshold.

Particular aspects of the subject matter described in this disclosure can be implemented to realize one or more of the following potential advantages. In some implementations, for example, various wireless communication devices (including one or more UEs and/or one or more network entities) may reduce energy consumption and achieve network energy savings (NES) by operating (such as communicating) in accordance with a cell DTX/DRX configuration because discontinuous operation may enable such wireless communication devices to enter sleep or relatively lower power modes during one or more non-active periods. Accordingly, such wireless communication devices may experience less power consumption and/or longer battery lives. Further, such wireless communication devices may achieve reduced energy consumption while also maintaining link quality (such as by maintaining accurate and/or up-to-date reference signal measurements) and/or sufficient data rates by selectively applying more or less signaling restrictions during cell DTX/DRX non-active periods in accordance with a length (such as a time duration) of the non-active periods and/or active periods, or some other criteria, as such an adaptive selection of signaling restrictions may enable wireless communication devices to more flexibly and dynamically balance link quality and/or data rates with energy savings. Moreover, by enabling a selection of signaling restrictions via a configured mapping, an indication in an activating DCI message, and/or some other criteria, UEs and network entities may achieve such a balance between energy savings, link quality, and/or data rates with efficient signaling overhead by avoiding, reducing, or otherwise limiting additional signaling. In accordance with such a balance between energy savings, link quality, and/or data rates with efficient signaling overhead, the subject matter of in this disclosure may be further implemented to realize greater reliability, higher data rates, greater spectral efficiency, and greater system capacity, among other benefits.

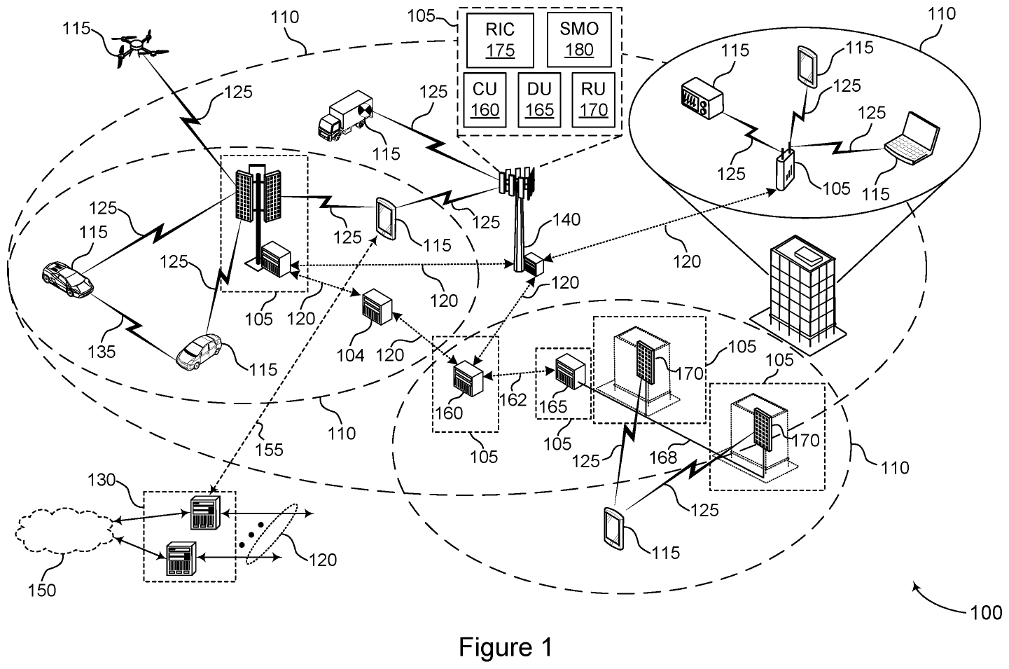

FIG. 1 shows an example wireless communication system 100 that supports adaptively restricting communication for cell discontinuous operation in accordance with one or more aspects of the present disclosure. The wireless communication system 100 may include one or more network entities 105, one or more UEs 115, and a core network 130. In some examples, the wireless communication system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communication system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (such as a radio frequency (RF) access link). For example, a network entity 105 may support a coverage area 110 (such as a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communication system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communication with various types of devices, such as other UEs 115 or network entities 105, as shown in FIG. 1.

A node of the wireless communication system 100, which may be referred to as a network node, a wireless communication device, or a wireless node, may be a network entity 105 (such as any network entity described herein), a UE 115 (such as any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (such as in accordance with an S1, N2, N3, or other interface protocol). In some examples, network entities 105 may communicate with one another via a backhaul communication link 120 (such as in accordance with an X2, Xn, or other interface protocol) either directly (such as directly between network entities 105) or indirectly (such as via a core network 130). In some examples, network entities 105 may communicate with one another via a midhaul communication link 162 (such as in accordance with a midhaul interface protocol) or a fronthaul communication link 168 (such as in accordance with a fronthaul interface protocol), or any combination thereof. The backhaul communication links 120, midhaul communication links 162, or fronthaul communication links 168 may be or include one or more wired links (such as an electrical link, an optical fiber link), one or more wireless links (such as a radio link, a wireless optical link), among other examples or various combinations thereof. A UE 115 may communicate with the core network 130 via a communication link 155.

One or more of the network entities 105 described herein may include or may be referred to as a base station 140 (such as a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (such as a base station 140) may be implemented in an aggregated (such as monolithic, standalone) base station architecture, which may be configured to utilize a protocol stack that is physically or logically integrated within a single network entity 105 (such as a single RAN node, such as a base station 140).

In some examples, a network entity 105 may be implemented in a disaggregated architecture (such as a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (such as a network configuration sponsored by the O-RAN Alliance), or a virtualized RAN (vRAN) (such as a cloud RAN (C-RAN)). For example, a network entity 105 may include one or more of a central unit (CU) 160, a distributed unit (DU) 165, a radio unit (RU) 170, a RAN Intelligent Controller (RIC) 175 (such as a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (such as separate physical locations). In some examples, one or more network entities 105 of a disaggregated RAN architecture may be implemented as virtual units (such as a virtual CU (VCU), a virtual DU (VDU), a virtual RU (VRU)).

The split of functionality between a CU 160, a DU 165, and an RU 170 is flexible and may support different functionalities depending on which functions (such as network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (such as layer 3 (L3), layer 2 (L2)) functionality and signaling (such as Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (such as physical (PHY) layer) or L2 (such as radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (such as via one or more RUs 170). In some cases, a functional split between a CU 160 and a DU 165, or between a DU 165 and an RU 170 may be within a protocol layer (such as some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (such as F1, F1-c, F1-u), and a DU 165 may be connected to one or more RUs 170 via a fronthaul communication link 168 (such as open fronthaul (FH) interface). In some examples, a midhaul communication link 162 or a fronthaul communication link 168 may be implemented in accordance with an interface (such as a channel) between layers of a protocol stack supported by respective network entities 105 that are in communication via such communication links.

In wireless communication systems (such as wireless communication system 100), infrastructure and spectral resources for radio access may support wireless backhaul link capabilities to supplement wired backhaul connections, providing an IAB network architecture (such as to a core network 130). In some cases, in an IAB network, one or more network entities 105 (such as IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (such as a donor base station 140). The one or more donor network entities 105 (such as IAB donors) may be in communication with one or more additional network entities 105 (such as IAB nodes 104) via supported access and backhaul links (such as backhaul communication links 120). IAB nodes 104 may include an IAB mobile termination (IAB-MT) controlled (such as scheduled) by DUs 165 of a coupled IAB donor. An IAB-MT may include an independent set of antennas for relay of communication with UEs 115, or may share the same antennas (such as of an RU 170) of an IAB node 104 used for access via the DU 165 of the IAB node 104 (such as referred to as virtual IAB-MT (vIAB-MT)). In some examples, the IAB nodes 104 may include DUs 165 that support communication links with additional entities (such as IAB nodes 104, UEs 115) within the relay chain or configuration of the access network (such as downstream). In such cases, one or more components of the disaggregated RAN architecture (such as one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support adaptively restricting communication for cell discontinuous operation. For example, some operations described as being performed by a UE 115 or a network entity 105 (such as a base station 140) may additionally, or alternatively, be performed by one or more components of the disaggregated RAN architecture (such as IAB nodes 104, DUs 165, CUs 160, RUs 170, RIC 175, SMO 180).

A UE 115 may include or may be referred to as a mobile device, a wireless communication device, a remote device, a handheld device, or a subscriber device, or some other suitable terminology. The “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communication (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (such as an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (such as a bandwidth part (BWP)) that is operated according to one or more physical layer channels for a given radio access technology (such as LTE, LTE-A, LTE-A Pro, NR). Each physical layer channel may carry acquisition signaling (such as synchronization signals, system information), control signaling that coordinates operation for the carrier, user data, or other signaling. The wireless communication system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (such as entity, sub-entity) of a network entity 105. For example, the terms “transmitting,” “receiving,” or “communicating,” in examples in which such terms refer to a network entity 105, may refer to any portion of a network entity 105 (such as a base station 140, a CU 160, a DU 165, a RU 170) of a RAN communicating with another device (such as directly or via one or more other network entities 105).

In some examples, such as in a carrier aggregation configuration, a carrier may also have acquisition signaling or control signaling that coordinates operations for other carriers. A carrier may be associated with a frequency channel (such as an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (such as of the same or a different radio access technology).

The communication links 125 shown in the wireless communication system 100 may include downlink transmissions (such as forward link transmissions) from a network entity 105 to a UE 115, uplink transmissions (such as return link transmissions) from a UE 115 to a network entity 105, or both, among other configurations of transmissions. Carriers may carry downlink or uplink communication (such as in an FDD mode) or may be configured to carry downlink and uplink communication (such as in a TDD mode).

A carrier may be associated with a particular bandwidth of the RF spectrum and, in some examples, the carrier bandwidth may be referred to as a “system bandwidth” of the carrier or the wireless communication system 100. For example, the carrier bandwidth may be one of a set of bandwidths for carriers of a particular radio access technology (such as 1.4, 3, 5, 10, 15, 20, 40, or 80 megahertz (MHz)). Devices of the wireless communication system 100 (such as the network entities 105, the UEs 115, or both) may have hardware configurations that support communication using a particular carrier bandwidth or may be configurable to support communication using one of a set of carrier bandwidths. In some examples, the wireless communication system 100 may include network entities 105 or UEs 115 that support concurrent communication using carriers associated with multiple carrier bandwidths. In some examples, each served UE 115 may be configured for operating using portions (such as a sub-band, a BWP) or all of a carrier bandwidth.

Signal waveforms transmitted via a carrier may be made up of multiple subcarriers (such as using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (such as a duration of one modulation symbol) and one subcarrier, in which case the symbol period and subcarrier spacing may be inversely related. The quantity of bits carried by each resource element may depend on the modulation scheme (such as the order of the modulation scheme, the coding rate of the modulation scheme, or both), such that a relatively higher quantity of resource elements (such as in a transmission duration) and a relatively higher order of a modulation scheme may correspond to a relatively higher rate of communication. A wireless communication resource may refer to a combination of an RF spectrum resource, a time resource, and a spatial resource (such as a spatial layer, a beam), and the use of multiple spatial resources may increase the data rate or data integrity for communication with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communication for the UE 115 may be restricted to one or more active BWPs.

The time intervals for the network entities 105 or the UEs 115 may be expressed in multiples of a basic time unit which may, for example, refer to a sampling period of TS=1/(Δfₘₐₓ·N_{f}) seconds, for which Δfₘₐₓ may represent a supported subcarrier spacing, and N_{f} may represent a supported discrete Fourier transform (DFT) size. Time intervals of a communication resource may be organized according to radio frames each having a specified duration (such as 10 milliseconds (ms)). Each radio frame may be identified by a system frame number (SFN) (such as ranging from 0 to 1023).

Each frame may include multiple consecutively-numbered subframes or slots, and each subframe or slot may have the same duration. In some examples, a frame may be divided (such as in the time domain) into subframes, and each subframe may be further divided into a quantity of slots. Alternatively, each frame may include a variable quantity of slots, and the quantity of slots may depend on subcarrier spacing. Each slot may include a quantity of symbol periods (such as depending on the length of the cyclic prefix prepended to each symbol period). In some wireless communication systems 100, a slot may further be divided into multiple mini-slots associated with one or more symbols. Excluding the cyclic prefix, each symbol period may be associated with one or more (such as N_{f}) sampling periods. The duration of a symbol period may depend on the subcarrier spacing or frequency band of operation.

A subframe, a slot, a mini-slot, or a symbol may be the smallest scheduling unit (such as in the time domain) of the wireless communication system 100 and may be referred to as a transmission time interval (TTI). In some examples, the TTI duration (such as a quantity of symbol periods in a TTI) may be variable. Additionally, or alternatively, the smallest scheduling unit of the wireless communication system 100 may be dynamically selected (such as in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (such as a control resource set (CORESET)) for a physical control channel may be defined by a set of symbol periods and may extend across the system bandwidth or a subset of the system bandwidth of the carrier. One or more control regions (such as CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (such as control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (such as using a carrier) and may be associated with an identifier for distinguishing neighboring cells (such as a physical cell identifier (PCID), a virtual cell identifier (VCID), or others). In some examples, a cell also may refer to a coverage area 110 or a portion of a coverage area 110 (such as a sector) over which the logical communication entity operates. Such cells may range from smaller areas (such as a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (such as several kilometers in radius) and may allow unrestricted access by the UEs 115 with service subscriptions with the network provider supporting the macro cell. A small cell may be associated with a lower-powered network entity 105 (such as a lower-powered base station 140), as compared with a macro cell, and a small cell may operate using the same or different (such as licensed, unlicensed) frequency bands as macro cells. Small cells may provide unrestricted access to the UEs 115 with service subscriptions with the network provider or may provide restricted access to the UEs 115 having an association with the small cell (such as the UEs 115 in a closed subscriber group (CSG), the UEs 115 associated with users in a home or office). A network entity 105 may support one or multiple cells and may also support communication via the one or more cells using one or multiple component carriers.

In some examples, a carrier may support multiple cells, and different cells may be configured according to different protocol types (such as MTC, narrowband IoT (NB-IoT), enhanced mobile broadband (eMBB)) that may provide access for different types of devices.

In some examples, a network entity 105 (such as a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communication system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (such as via Machine-to-Machine (M2M) communication). M2M communication or MTC may refer to data communication technologies that allow devices to communicate with one another or a network entity 105 (such as a base station 140) without human intervention. In some examples, M2M communication or MTC may include communication from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communication (such as a mode that supports one-way communication via transmission or reception, but not transmission and reception concurrently). In some examples, half-duplex communication may be performed at a reduced peak rate. Other power conservation techniques for the UEs 115 include entering a power saving deep sleep mode in examples in which the UEs 115 are not engaging in active communication, operating using a limited bandwidth (such as according to narrowband communication), or a combination of these techniques. For example, some UEs 115 may be configured for operation using a narrowband protocol type that is associated with a defined portion or range (such as set of subcarriers or resource blocks (RBs)) within a carrier, within a guard-band of a carrier, or outside of a carrier.

The wireless communication system 100 may be configured to support ultra-reliable communication or low-latency communication, or various combinations thereof. For example, the wireless communication system 100 may be configured to support ultra-reliable low-latency communication (URLLC). The UEs 115 may be designed to support ultra-reliable, low-latency, or critical functions. Ultra-reliable communication may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (such as in accordance with a peer-to-peer (P2P), D2D, or sidelink protocol). In some examples, one or more UEs 115 of a group that are performing D2D communication may be within the coverage area 110 of a network entity 105 (such as a base station 140, an RU 170), which may support aspects of such D2D communication being configured by (such as scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communication may support a one-to-many (1:M) system in which each UE 115 transmits to each of the other UEs 115 in the group. In some examples, a network entity 105 may facilitate the scheduling of resources for D2D communication. In some other examples, D2D communication may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (such as a mobility management entity (MME), an access and mobility management function (AMF)) and at least one user plane entity that routes packets or interconnects to external networks (such as a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (such as base stations 140) associated with the core network 130. User IP packets may be transferred—the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communication system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communication using UHF waves may be associated with smaller antennas and shorter ranges (such as less than 100 kilometers) compared to communication using the smaller frequencies and longer waves of the high frequency (HF) or very high frequency (VHF) portion of the spectrum below 300 MHz.

The wireless communication system 100 may also operate using a super high frequency (SHF) region, which may be in the range of 3 GHz to 30 GHz, also known as the centimeter band, or using an extremely high frequency (EHF) region of the spectrum (such as from 30 GHz to 300 GHz), also known as the millimeter band. In some examples, the wireless communication system 100 may support millimeter wave (mmW) communication between the UEs 115 and the network entities 105 (such as base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communication system 100 may utilize both licensed and unlicensed RF spectrum bands. For example, the wireless communication system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (such as LAA). Operations using unlicensed spectrum may include downlink transmissions, uplink transmissions, P2P transmissions, or D2D transmissions, among other examples.

A network entity 105 (such as a base station 140, an RU 170) or a UE 115 may be equipped with multiple antennas, which may be used to employ techniques such as transmit diversity, receive diversity, multiple-input multiple-output (MIMO) communication, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communication with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (such as a network entity 105, a UE 115) to shape or steer an antenna beam (such as a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (such as with respect to the antenna array of the transmitting device or receiving device, or with respect to some other orientation).

A network entity 105 or a UE 115 may use beam sweeping techniques as part of beamforming operations. For example, a network entity 105 (such as a base station 140, an RU 170) may use multiple antennas or antenna arrays (such as antenna panels) to conduct beamforming operations for directional communication with a UE 115. Some signals (such as synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (such as by a transmitting device, such as a network entity 105, or by a receiving device, such as a UE 115) a beam direction for later transmission or reception by the network entity 105.

Some signals, such as data signals associated with a particular receiving device, may be transmitted by transmitting device (such as a transmitting network entity 105, a transmitting UE 115) along a single beam direction (such as a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (such as by a network entity 105 or a UE 115) may be performed using multiple beam directions, and the device may use a combination of digital precoding or beamforming to generate a combined beam for transmission (such as from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (such as a cell-specific reference signal (CRS), a channel state information (CSI) reference signal (CSI-RS)), which may be precoded or unprecoded. The UE 115 may provide feedback for beam selection, which may be a precoding matrix indicator (PMI) or codebook-based feedback (such as a multi-panel type codebook, a linear combination type codebook, a port selection type codebook). Although these techniques are described with reference to signals transmitted along one or more directions by a network entity 105 (such as a base station 140, an RU 170), a UE 115 may employ similar techniques for transmitting signals multiple times along different directions (such as for identifying a beam direction for subsequent transmission or reception by the UE 115) or for transmitting a signal along a single direction (such as for transmitting data to a receiving device).

A receiving device (such as a UE 115) may perform reception operations in accordance with multiple receive configurations (such as directional listening) in examples in which the UE 115 receives various signals from a transmitting device (such as a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (such as different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (such as in accordance with receiving a data signal). The single receive configuration may be aligned along a beam direction determined based on listening according to different receive configuration directions (such as a beam direction determined to have a highest signal strength, highest signal-to-noise ratio (SNR), or otherwise acceptable signal quality based on listening according to multiple beam directions).

A network entity 105 and a UE 115 may communicate (such as transmit and/or receive) according to a discontinuous operation configuration. For example, the discontinuous operation configuration may include a cell DTX configuration and/or a cell DRX configuration. In other words, the UE 115 may communicate with a serving cell according to the discontinuous operation configuration. In some examples, the serving cell may be associated with the coverage area 110. The UEs 115 in the coverage area 110 may communicate with (such as via) the serving cell according to the discontinuous operation configuration. The discontinuous operation configuration may include non-active periods in which a wireless communication device, such as the network entity 105 and/or the UE 115, may reduce energy consumption by entering a sleep or low power mode. In other words, the discontinuous operation configuration may support NES at the network entity 105 and/or the UE 115.

The network entity 105 and/or the UE 115 may maintain a link quality and/or data rate by applying signaling restrictions according to (such as in accordance with or based on) a length of the non-active periods, a length of the active periods, and/or an indication. For example, the UE 115 may receive a DCI from the network entity 105 that indicates a signaling restriction set to apply for a discontinuous operation configuration or may otherwise select a signaling restriction set from multiple available (such as previously indicated or configured) signaling restriction sets in accordance with one or more criteria. In such examples, the network entity 105 and/or the UE 115 may balance energy savings with link quality and/or data rates by adaptively applying signaling restrictions, as some signaling restriction sets may prioritize energy savings and some other signaling restriction sets may prioritize link quality and/or data rates.

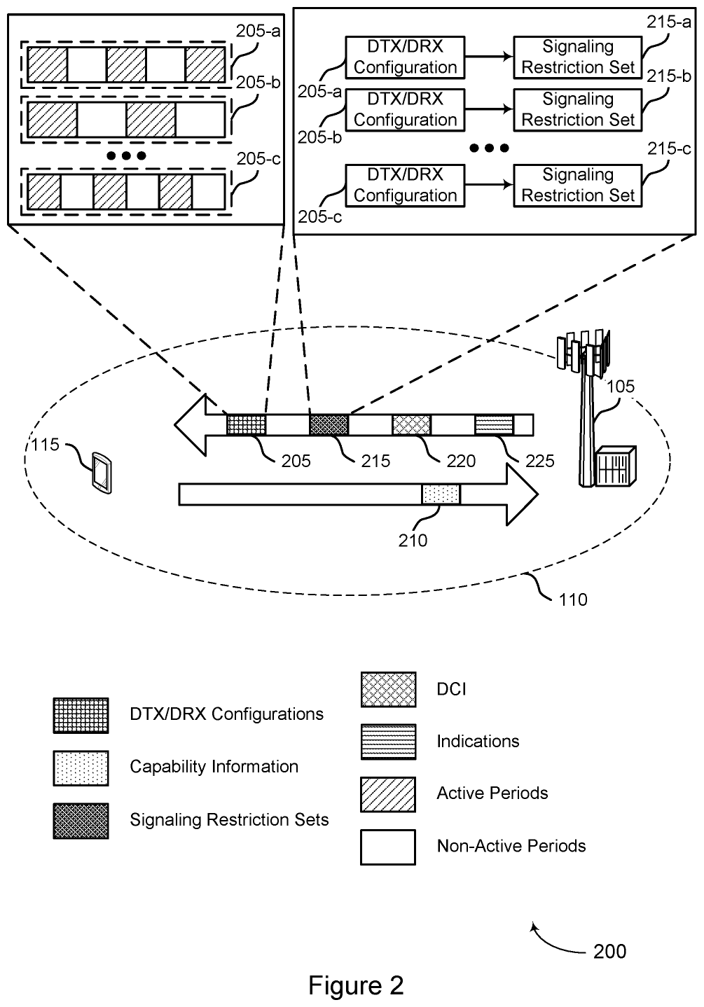

FIG. 2 shows an example wireless communication system 200 that supports adaptively restricting communication for cell discontinuous operation in accordance with one or more aspects of the present disclosure. The wireless communication system 200 may implement or be implemented by various aspects of the wireless communication system 100. For example, the wireless communication system 200 may include a network entity 105, a coverage area 110, and a UE 115, which may represent examples of corresponding devices as illustrated by and described with reference to FIG. 1.

The network entity 105 and/or the UE 115 may communicate according to a discontinuous operation of a serving cell. For example, the serving cell may be associated with the coverage area 110 including the UE 115, potentially among other wireless communication devices. The discontinuous operation may include cell DTX and/or cell DRX, which may be referred to or understood as cell DTX/DRX. For example, the network entity 105 may communicate (such as transmit and/or receive) during active periods of the discontinuous operation, and restrict communication during inactive (such as non-active) periods of the discontinuous operation.

The network entity 105 may transmit a control message (such as an RRC message) indicating cell DTX/DRX configurations 205. For example, the control message may include information indicative of multiple cell DTX/DRX configurations 205, including a cell DTX/DRX configuration 205-a, a cell DTX/DRX configuration 205-b, and/or a cell DTX/DRX configuration 205-c. The cell DTX/DRX configurations 205 may each include different DTX/DRX cycles having active periods and non-active periods. In other words, a DTX/DRX cycle may include multiple active periods and multiple inactive periods that cycle back and forth over time. The cell DTX/DRX configurations 205, in some aspects, may be referred to as discontinuous communication cycle configurations and may generally be associated with (such as understood as) cell discontinuous operation. The network entity 105 may indicate the cell DTX/DRX configurations 205 to the UE 115 and other devices of the serving cell such that the UE 115 may refrain from communicating with the network entity 105 during the inactive periods and otherwise understand times at which to expect communication with the network entity 105 via the serving cell.

In some examples, the network entity 105 may restrict channels, signals, or both during inactive periods of a cell DTX/DRX configuration 205. For example, the network entity 105 may communicate one or more signals during the inactive periods according to a signaling restriction set 215, which may generally refer any one or more of a signaling restriction set 215-a, a signaling restriction set 215-b, and a signaling restriction set 215-c. The UE 115 may transmit an indication of capability information 210 to the network entity 105, the capability information 210 indicating a capability of the UE 115 to support different restrictions. In other words, the UE 115 may indicate which restrictions it is capable of supporting, for example, to maintain a link quality, in accordance with a latency tolerance, or to maintain a power level, among other examples. In some aspects, the UE 115 may indicate whether the UE 115 is capable of communicating in accordance with a single signaling restriction set 215 or multiple signaling restriction sets 215.

The network entity 105 may transmit a control message (such as an RRC message) indicating signaling restriction sets 215 to the UE 115. In some examples, the network entity 105 may indicate the signaling restriction sets 215 after receiving the capability information 210. The signaling restriction sets 215 may include respective sets of restrictions to physical channels, physical signals, and/or logical channels, among other examples.

The UE 115 may apply one of the signaling restriction sets 215 in accordance with receiving a mapping of the signaling restriction sets 215 to the cell DTX/DRX configurations 205, in accordance with receiving a DCI 220 indicating one of the signaling restriction sets 215, in accordance with a criteria (such as a criteria indicated to the UE 115 or obtained from a memory of the UE 115), and/or in accordance with one or more thresholds for non-active durations and/or active durations, among other examples. In other words, the network entity 105 may indicate the signaling restriction sets 215 and how they are to be used by the UE 115 in one or more of various ways.

For example, the control message indicating the signaling restriction sets 215 may indicate a mapping (such as an association) between respective cell DTX/DRX configurations 205 and signaling restriction sets 215. For example, the control message may indicate that the cell DTX/DRX configuration 205-a is associated with the signaling restriction set 215-a, that the cell DTX/DRX configuration 205-b is associated with the signaling restriction set 215-b, and that the cell DTX/DRX configuration 205-c is associated with the signaling restriction set 215-c. In some examples, the one or more control messages indicating the cell DTX/DRX configurations 205 and the signaling restriction sets 215 may be of a same set of control messages. In other words, the network entity 105 may indicate the cell DTX/DRX configurations 205 and the signaling restriction sets 215 to the UE 115 simultaneously (such as via a same control message, such as via different fields or information elements of the same control message).

Additionally, or alternatively, the network entity 105 may transmit a DCI 220 to the UE 115 activating and/or deactivating a specified cell DTX/DRX configuration of the cell DTX/DRX configurations 205. For example, the network entity 105 may transmit the DCI 220 to activate a cell DTX/DRX configuration to be used by the UE 115 to communicate with the network entity 105. In some examples, the DCI 220 may indicate a signaling restriction set associated with the activated cell DTX/DRX configuration. In such examples, the UE 115 may communicate with the network entity 105 during active periods of the activated cell DTX/DRX configuration (such as with no restrictions) and during inactive periods of the activated cell DTX/DRX configuration according to the indicated signaling restriction set.

In some examples, the network entity 105 may transmit indications 225 to the UE 115 and the UE 115 may select and implement a signaling restriction set of the signaling restriction sets 215 according to the indications 225. For example, the indications 225 may include one or more thresholds for durations of non-active periods, active periods, or both. In such examples, the UE 115 may select a signaling restriction set in association with comparing a duration of anon-active period and/or active period of a cell DTX/DRX configuration (such as an activated cell DTX/DRX configuration) to the one or more thresholds. Additionally, or alternatively, the indications 225 may include an indication of a criteria and the UE 115 may select the signaling restriction set in association with receiving the indication of the criteria (such as in accordance with or otherwise based on the criteria).

In some implementations, the UE 115 may apply the signaling restriction sets 215 according to a function of the duration of the inactive period and/or the active period. For example, a relatively longer inactive period (such as relative to inactive periods of other cell DTX/DRX configurations and/or relative to the active period) may be associated with relatively fewer restrictions while a relatively shorter inactive period may be associated with relatively more restrictions. In other words, the UE 115 may adapt the restrictions according to the duration of the inactive period of the activated cell DTX/DRX configuration.

The UE 115 may communicate according to one or more of the cell DTX/DRX configurations 205 and one or more of the signaling restriction sets 215 to support reduced energy consumption while maintaining link quality and/or data rates. In other words, the UE 115 may adaptively restrict signals and/or channels in accordance with applying signaling restriction sets 215 according to indications from the network entity 105 (such as via mapping within control messages, via DCI, and/or via indications, among other examples) and/or according to a criteria at the UE 115.

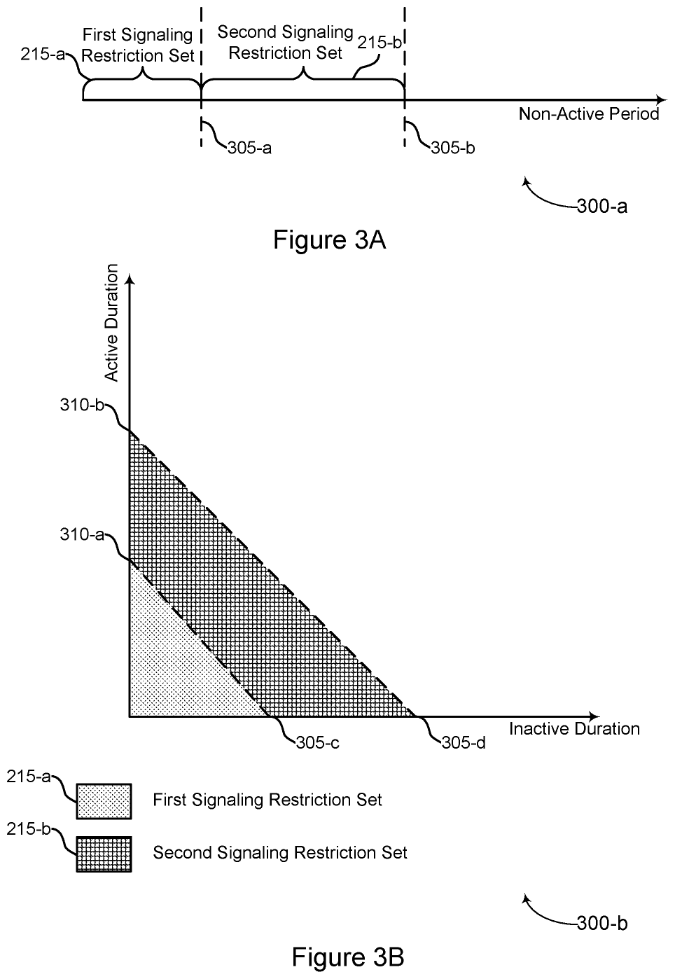

FIGS. 3A and 3B show example signaling restriction set thresholds 300-a and 300-b that support adaptively restricting communication for cell discontinuous operation in accordance with one or more aspects of the present disclosure. The signaling restriction set thresholds 300-a and 300-b may implement or be implemented by various aspects of the wireless communication system 100, the wireless communication system 200, or both. For example, the signaling restriction set thresholds 300-a and 300-b may be implemented by a UE 115, which may represent an example of corresponding devices as illustrated by and described with reference to FIGS. 1 and 2. As described herein, a duration may refer to a time span of a period and/or a length of a period in units of time.

A network entity, which may be an example of a network entity 105 as illustrated by and described with reference to FIGS. 1 and 2, may indicate cell DTX/DRX configurations and signaling restriction sets to the UE. The UE may apply a signaling restriction set in accordance with an indicated mapping between the cell DTX/DRX configurations and signaling restriction sets, in accordance with comparing durations of inactive and/or active periods of the DTX/DRX configurations to one or more thresholds, and/or in accordance with a criteria, among other examples. In the example of FIG. 3A and FIG. 3B, the UE may receive an indication of one or more non-active duration thresholds and/or one or more active duration thresholds in accordance with which the UE may select a signaling restriction set to apply for communication during inactive periods of a cell DTX/DRX configuration.

For example, the network entity may indicate the signaling restriction set thresholds 300-a to the UE. In some implementations, the signaling restriction set thresholds 300-a may include a non-active duration threshold 305-a and a non-active duration threshold 305-b. The non-active duration threshold 305-a and the non-active duration threshold 305-b may be associated with a first signaling restriction set 215-a and a second signaling restriction set 215-b, respectively.

The first signaling restriction set 215-a may be applied to DTX/DRX configurations having non-active periods below the non-active duration threshold 305-a, while the second signaling restriction set 215-b may be applied to DTX/DRX configurations having non-active periods with durations below the non-active duration threshold 305-b and above the non-active duration threshold 305-a. Additionally, or alternatively, while not explicitly shown in the example of FIG. 3A, it may be understood that a third signaling restriction set may be applied to DTX/DRX configurations having non-active periods above the non-active duration threshold 305-b. For example, the third signaling restriction set may include no restrictions or a smallest allowed quantity of restrictions.

In some implementations, the first signaling restriction set 215-a may include a relatively greater quantity of restrictions compared to the second signaling restriction set 215-b. For example, the first signaling restriction set 215-a, which may be applied to cell DTX/DRX configurations having non-active periods with durations less than the non-active duration threshold 305-a (such as a lowest non-active duration threshold) may include relatively more aggressive (such as a greater quantity of) restrictions relative to the other signaling restriction sets.

Likewise, the second signaling restriction set 215-b may include a relatively smaller quantity of restrictions compared to the first signaling restriction set 215-a. For example, the second signaling restriction set 215-b, which may be applied to cell DTX/DRX configurations having non-active periods with durations below the non-active duration threshold 305-b (such as a highest non-active duration threshold) and above the non-active duration threshold 305-a (such as a lowest non-active duration threshold) may include relatively more relaxed (such as a smaller quantity of) restrictions relative to the first signaling restriction set 215-a.

In other words, the non-active duration thresholds 305-a and 305-b may generally be configured such that the UE may apply more relaxed restrictions as the duration of the non-active period increases. For example, a UE, in accordance with communicating according to a cell DTX/DRX configuration having a non-active period with a relatively large duration (such as larger than the non-active duration threshold 305-b), may experience degraded link quality (such as compared to communication during an active period) in examples in which reference signals are restricted to active periods. In other words, reference signal measurements may degrade in accuracy after a time of measurement, and a UE using these reference signal measurements for an extended duration (because of a restriction of reference signals during non-active periods) may experience poor link quality. Accordingly, relaxing restrictions for non-active periods with durations greater than the non-active duration threshold 305-b may enable the UE to maintain the link quality by updating reference signal measurements, as some reference signals may be allowed to be transmitted and/or received between the UE and the network entity in accordance with relatively more relaxed restrictions.

In some aspects, signaling restriction sets may be understood as different subsets of a larger signaling restriction set. For example, the first signaling restriction set 215-a, having relatively aggressive (such as a greater quantity of) restrictions, may include all the restrictions of the larger signaling restriction set. In such examples, the second signaling restriction set 215-a may be a subset of the larger signaling restriction set, excluding some restrictions of the larger signaling restriction set. In other words, as restrictions are relaxed (such as corresponding to the non-active period increasing), the subset of restrictions of the larger signaling restriction set may become progressively smaller (such as until the non-active period is sufficiently large and no restrictions, or a smallest allowed quantity of restrictions, are applied).

Further, although the signaling restriction set thresholds 300-a is illustrated and described as including two non-active duration thresholds, it may be understood that less than two or more than two non-active duration thresholds may be indicated and/or applied to select a signaling restriction set. For example, the UE may receive an indication of a single threshold. The UE may either apply signaling restrictions or may not apply signaling restrictions in accordance with comparing the duration of the non-active period of the cell DTX/DRX configuration to the threshold. Alternatively, the UE may either apply a first signaling restriction set or a second signaling restriction set in accordance with comparing the duration of the non-active period of the cell DTX/DRX configuration to the threshold. In some other examples, the UE may receive an indication of two or more thresholds, each threshold differentiating between two available signaling restriction sets.

In the example of FIG. 3B, the network entity may indicate the signaling restriction set thresholds 300-b to the UE. The signaling restriction set thresholds 300-b may include a non-active duration threshold 305-c, a non-active duration threshold 305-d, an active duration threshold 310-a, and an active duration threshold 310-b. In some aspects, a plot of the non-active duration threshold 305-c, the non-active duration threshold 305-d, the active duration threshold 310-a, and the active duration threshold 310-b may include a first area corresponding to the first signaling restriction set 215-a and a second area corresponding to the second signaling restriction set 215-b.

Additionally, or alternatively, while not explicitly shown in the example of FIG. 3B, it may be understood that the plot may include a third signaling restriction set corresponding to an area beyond the non-active duration threshold 305-d and the active duration threshold 310-b. For example, the third signaling restriction set may include no restrictions or a smallest allowed quantity of restrictions.

The first area of the plot corresponding to the first signaling restriction set 215-a may be below a first threshold line from the non-active duration threshold 305-c to the active duration threshold 310-a. Additionally, or alternatively, the second area of the plot corresponding to the second signaling restriction set 215-a may be a non-overlapping portion relative to the first area below a second threshold line from the non-active duration threshold 305-d to the active duration threshold 310-b. In other words, the second area of the plot may be an area below the second threshold line which does not overlap with (such as excluding) the first area.

In some implementations, the first signaling restriction set 215-a may include a relatively greater quantity of restrictions compared to the second signaling restriction set 215-b. For example, the first signaling restriction set 215-a, may include relatively more aggressive (such as a greater quantity of) restrictions relative to the other signaling restriction sets. Likewise, the second signaling restriction set 215-b may include a relatively smaller quantity of restrictions compared to the first signaling restriction set 215-a. For example, the second signaling restriction set 215-b, may include relatively more relaxed (such as a smaller quantity of) restrictions relative to the first signaling restriction set 215-a.

In some examples, the active duration threshold 310-a may be greater than the active duration threshold 310-b. For example, as the duration of the active period increases, the UE may complete transmissions during the active period such that relaxed restrictions during the non-active period are not as useful compared to examples in which the active period is relatively short. In other words, the network entity may configure the active duration thresholds 310-a and 310-b such that the UE may apply more relaxed restrictions as the duration of the non-active period increases relative to the duration of the active period.

In examples in which a UE communicates according to a cell DTX/DRX configuration having a relatively short active period relative to active periods of other cell DTX/DRX configurations, may experience degraded link quality associated with signals being restricted to active periods. In other words, the active period may be relatively short such that the UE may not complete transmissions (such as high priority transmissions) or obtain sufficient reference signal measurements during the active period. The network entity may configure more relaxed restrictions for shorter active periods at the UE such that the UE may complete the transmissions outside of the active period.

While the signaling restriction set thresholds 300-b includes two non-active duration thresholds and two active duration thresholds, it may be understood that less than two or more than two non-active duration thresholds and/or active duration thresholds may be indicated and/or applied to select a signaling restriction set. For example, the UE may receive an indication of a single threshold (such as a single non-active duration threshold and/or a single non-active duration threshold). The UE may either apply signaling restrictions or may not apply signaling restrictions in accordance with comparing the durations of the active or non-active periods of the cell DTX/DRX configuration to the threshold. Alternatively, the UE may either apply a first signaling restriction set or a second signaling restriction set in accordance with comparing the durations of the active or non-active periods of the cell DTX/DRX configuration to the threshold. In some other examples, the UE may receive an indication of two or more thresholds (such as two or more non-active duration thresholds and two or more active duration thresholds).

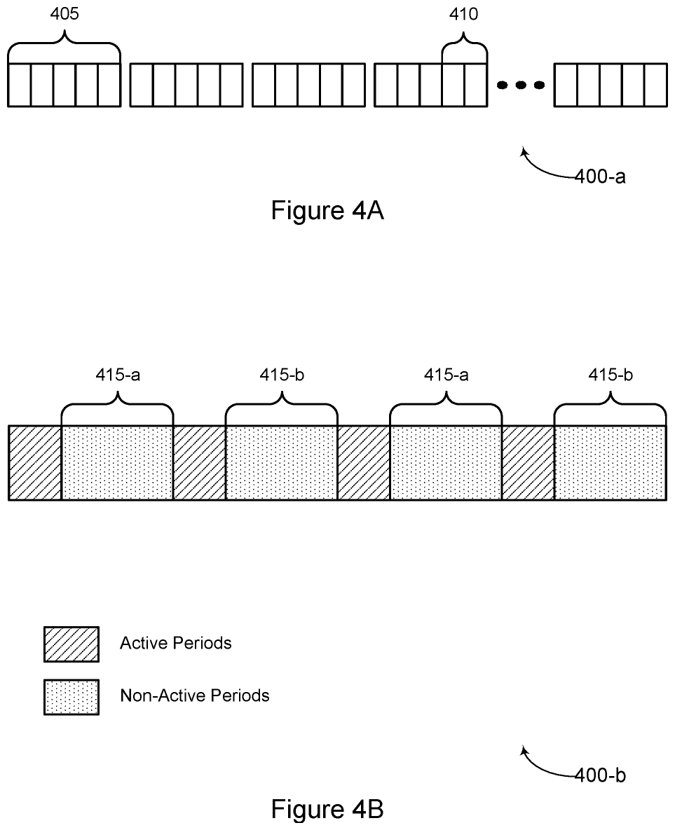

FIG. 4A shows an example DCI message 400-a that supports adaptively restricting communication for cell discontinuous operation in accordance with one or more aspects of the present disclosure. The DCI diagram may implement or be implemented by various aspects of the wireless communication system 100, the wireless communication system 200, or both. For example, the DCI diagram including the DCI message 400-a (which may be equivalently referred to as DCI or a DCI format) may be communicated between a network entity 105 and a UE 115, each of which may represent examples of corresponding devices as illustrated by and described with reference to FIGS. 1 and 2.

For example, a network entity may indicate cell DTX/DRX configurations and signaling restriction sets to the UE. The UE may apply a signaling restriction set in accordance with an indicated mapping between the cell DTX/DRX configurations and signaling restriction sets, in accordance with comparing durations of inactive and/or active periods of the cell DTX/DRX configurations to thresholds, and/or in accordance with a criteria, among other examples. In the example of FIG. 4A, the network entity may indicate a signaling restriction set to be applied for communication at the UE via the DCI message 400-a.

The DCI message 400-a may include indications for respective UEs. The DCI message 400-a, in some aspects, may be a group common DCI. For example, a UE of multiple UEs in a coverage area of the network entity may receive the DCI and identify an indication 405 that is associated with the UE. The UE may identify the indication 405 associated with the UE in accordance with an RRC message indicating a location in the DCI corresponding to the UE. In other words, the network entity may transmit a common DCI (such as a group DCI) to multiple UEs and the DCI may include indications for respective UEs.

The DCI message 400-a may activate and/or deactivate a cell DTX/DRX configuration (such as via L1 activation and/or deactivation). For example, the indication 405 may include one or more bits activating the cell DTX/DRX configuration (such as first bits). In other words, the network entity may transmit a same DCI message 400-a, which may be understood as a group common DCI, to multiple UEs in a serving cell to activate and/or deactivate the cell DTX/DRX configuration for the cell.

Additionally, or alternatively, the DCI message 400-a may indicate a signaling restriction set to be applied for communication at the UE. In some aspects, one or more bits 410 of an indication (such as a last or final two bits 410 within an indication pertaining to a specific UE) may be an index associated with a signaling restriction set according to a table configured at the UE. For example, the network entity may indicate the cell DTX/DRX configurations and the signaling restriction sets to the UE via one or more RRC messages (such as together or separately) and the one or more RRC messages may configure the UE with the table, with respective indices being associated with respective restriction types. The restriction types may indicate signals which are subject to restriction during a non-active period of an activated cell DTX/DRX configuration. In other words, the signals listed under “restriction type” may be understood to be included in a signaling restriction set. As an example, the one or more RRC messages may configure the UE with Table 1 below.

TABLE 1

| Index | Restriction Type |
|---|---|
| 00 | Dynamic grants |
| 01 | Dynamic grants and configured grants (such as semi-persistent |
| | scheduling (SPS) or configured grant (CG), among other examples) |
| 10 | Dynamic grants, configured grants, and low priority uplink |
| | control information (UCI) |
| 11 | Dynamic grants, configured grants, and high priority UCI |

In examples in which the two bits 410 convey or point to an index “00,” the associated restriction type may be “dynamic grants” as indicated by Table 1. In such examples, the UE may be unable to communicate dynamic grants during a non-active period of an activated cell DTX/DRX configuration. Alternatively, in examples in which the two bits 410 convey or point to an index “10,” the associated restriction type may be “dynamic grants, configured grants, and low priority UCI” as indicated by Table 1. In such examples, the UE may be unable to communicate dynamic grants, configured grants, and low priority UCI during a non-active period of an activated cell DTX/DRX configuration. In other words, the DCI message 400-a activating a cell DTX/DRX configuration may also indicate the signaling restriction set to be used during the non-active periods of the activated cell DTX/DRX configuration.

In some examples, the DCI message 400-a may include a codepoint corresponding to a configuration for scheduling request (SR) restrictions. For example, the codepoint may indicate, to the UE, which SRs are permitted to be communicated during the non-active period. Table 2 below may represent an example of codepoints and corresponding configurations for SR restrictions. For example, the codepoint may generally indicate which SRs may be transmitted during a non-active period of an activated cell DTX/DRX configuration.

TABLE 2

| Codepoint | Scheduling Request Restrictions |
|---|---|
| 1 | All logical channels active and cell DTX/DRX restrictions |
| | do not apply |
| 2 | High priority scheduling requests are active and a UE may |
| | bypass cell DRX restrictions for a high priority SR |
| 3 | SRs and data (such as CG) are active and a UE may bypass |
| | cell DRX restrictions for high priority SRs and/or data |
| | transmissions (such as high priority CG) |
| 4 | SRs and data inactive for all logical channels |

Additionally, or alternatively, the DCI message 400-a may include a codepoint indicating whether the UE is to follow a connected mode DRX (C-DRX) configuration or a cell DTX/DRX configuration. Table 3 below may represent an example of codepoints and corresponding configurations for UE discontinuous operations.

TABLE 3

| Codepoint | UE Discontinuous Operation Mode |
|---|---|
| 1 | UE to follow C-DRX, Cell DTX/DRX configuration is not |
| | active |
| 2 | UE ignores C-DRX configuration and follows cell DTX/DRX |
| 3 | UE follows a special C-DRX pattern that is active in examples |
| | in which cell DTX/DRX is active |
| 4 | UE follows C-DRX rules, but cell DTX rules may override |
| | C-DRX rules |

For example, the network entity may configure one or more UEs in the serving cell to follow the cell DTX/DRX configuration. As an example, the UE may communicate according to a C-DRX configuration and a non-active period of the C-DRX operation may overlap with an active period of a cell DTX configuration. In other words, the non-active periods of the C-DRX configuration may overlap (such as at least partially) with active periods of the cell DTX configuration. Accordingly, the network entity may configure UEs, via the DCI message 400-a, to follow the cell DTX/DRX configuration or the C-DRX configuration.

Additionally, or alternatively, the DCI message 400-a may indicate spatial and/or power adaptation states. For example, the UE may adapt a CSI-RS measurement and reporting associated with the indicated spatial and/or power adaptation states.

FIG. 4B shows an example discontinuous operation cycle 400-b that supports adaptively restricting communication for cell discontinuous operation in accordance with one or more aspects of the present disclosure. The discontinuous operation cycle 400-b may implement or be implemented by various aspects of the wireless communication system 100, the wireless communication system 200, or both. For example, the discontinuous operation cycle 400-b may be implemented by a network entity 105 and indicated to a UE 115, each of which may represent examples of corresponding devices as illustrated by and described with reference to FIGS. 1 and 2.

For example, a network entity may indicate the discontinuous operation cycle 400-b (such as a cycle associated with a cell DTX/DRX configuration) to the UE such that the UE may refrain from communicating (such as entirely or selected signals) with the network entity during inactive periods of the discontinuous operation cycle 400-b. In the example of FIG. 4B, the network entity may indicate signaling restriction sets to be applied periodically for communication at the UE.

For example, the UE may periodically apply a first signaling restriction set 415-a to a first inactive period and a second signaling restriction set 415-b to a second inactive period of the discontinuous operation cycle 400-b. In other words, the UE may apply the first signaling restriction set 415-a to odd inactive periods and the second signaling restriction set 415-b to even inactive periods (such as counting from a start of the discontinuous operation cycle 400-b). As an example, the first signaling restriction set 415-a may restrict dynamic grants and the second signaling restriction set may restrict dynamic grants and low priority UCI.

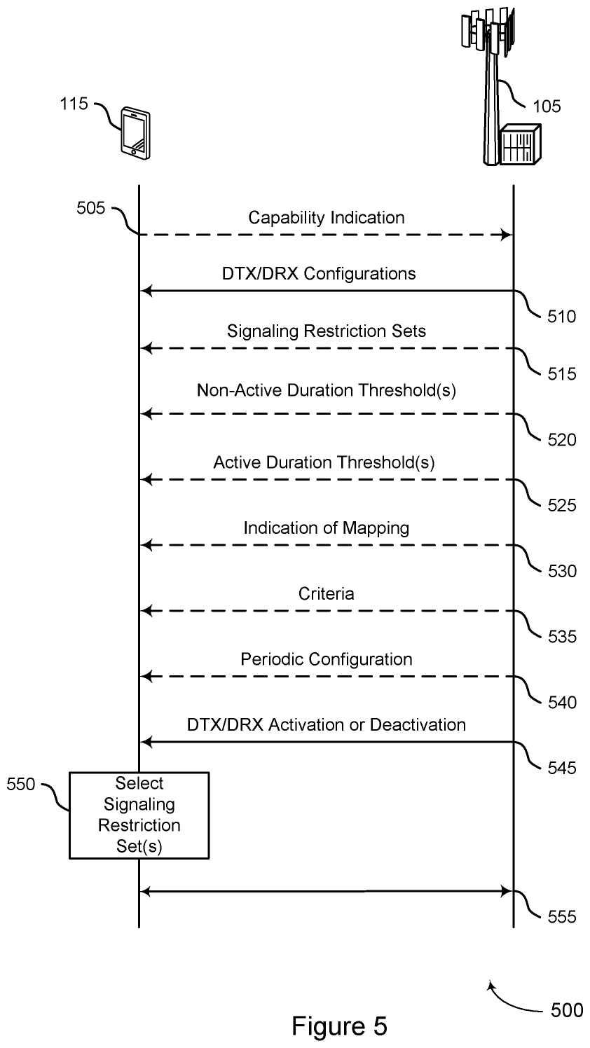

FIG. 5 shows an example process flow 500 that supports adaptively restricting communication for cell discontinuous operation in accordance with one or more aspects of the present disclosure. In some examples, the process flow 500 may implement or be implemented by aspects of the wireless communication system 100, the wireless communication system 200, the signaling restriction set thresholds 300-a and 300-b, the DCI message 400-a, and/or the discontinuous operation cycle 400-b as described with reference to FIGS. 1-4. For example, the process flow 500 may include a network entity 105 and a UE 115, which may be examples of corresponding devices as illustrated by and described with reference to FIGS. 1 and 2.

Alternative examples of the following may be implemented. Some steps are performed in a different order than described or are not performed at all. In some cases, steps may include additional features not mentioned below, or further steps may be added. Although the network entity 105 and the UE 115 are shown performing the operations of the process flow 500, some aspects of some operations may also be performed by one or more other wireless communication devices (such as by multiple network entities 105, or in accordance with coordination among multiple network entities 105).

The network entity 105 may indicate cell DTX/DRX configurations and signaling restriction sets to the UE 115, in accordance with which the UE 115 may communicate with the network entity 105 during non-active periods of the DTX/DRX configurations. For example, the UE 115 may apply a signaling restriction set in accordance with an indicated mapping between the DTX/DRX configurations and signaling restriction sets, in accordance with comparing durations of inactive and/or active periods of the DTX/DRX configurations to thresholds, or in accordance with a criteria, among other examples.

At 505, the UE 115 may transmit capability information to the network entity 105. For example, the UE 115 may transmit an indication of a capability, of the UE 115, to support multiple signaling restriction sets. In some aspects, the capability may be associated with maintaining a link quality, maintaining data rates, and/or conserving energy at the UE 115.

At 510, the network entity 105 may indicate one or multiple cell DTX/DRX configurations to the UE 115. The network entity 105 may indicate the cell DTX/DRX configurations via one or more first control messages. That is, the one or more first control messages may include information indicative of multiple cell DTX/DRX configurations associated with a serving cell. In some aspects, each cell DTX/DRX configuration may be associated with a respective DTX/DRX cycle. For example, respective DTX/DRX cycles may have different active periods, different inactive periods, or both.

At 515, the network entity 105 may indicate signaling restriction sets to the UE 115. For example, the network entity 105 may indicate the signaling restriction sets via one or more second control messages. That is, the one or more second control messages may include information indicative of the signaling restriction sets. Each signaling restriction set may be associated with one or more cell DTX/DRX configurations. Each signaling restriction set may include one or more respective signaling restrictions associated with communication between the UE 115 and the serving cell over a non-active period of a respective DTX/DRX cycle. In other words, each signaling restriction set may include signals, channels, or both that the UE 115 may refrain from communicating during a non-active period of an activated cell DTX/DRX configuration.

In some examples, the indicated signaling restriction sets may be in accordance with the capability information. For example, the network entity 105 may select the signaling restriction sets to be used by the UE 115 in accordance with receiving the capability information of the UE 115 at 505.

In some implementations, the network entity 105 may transmit the cell DTX/DRX configurations and the signaling restriction sets via a same set of one or more control messages. For example, the network entity 105 may transmit the DTX/DRX configurations and the signaling restriction sets via an RRC message (such as a single RRC message or multiple RRC messages).

At 520, the network entity 105 may indicate one or more non-active duration thresholds to the UE 115. For example, the network entity 105 may indicate a single non-active duration threshold or multiple non-active duration thresholds associated with the signaling restriction sets. Each signaling restriction set may correspond to a subset of cell DTX/DRX configurations in accordance with the indicated non-active duration thresholds (such as described with reference to FIG. 3A).

In some examples, the network entity 105 may indicate the single non-active duration threshold. In such examples, a first signaling restriction set may correspond to a first subset of cell DTX/DRX configurations, each cell DTX/DRX configuration of the first subset of cell DTX/DRX configurations being associated with a respective first DTX/DRX cycle having a non-active period with a duration greater than a non-active duration threshold. A second signaling restriction set may correspond to a second subset of cell DTX/DRX configurations, each cell DTX/DRX configuration of the second subset of cell DTX/DRX configurations being associated with a respective second DTX/DRX cycle having a non-active period with a duration less than or equal to the non-active duration threshold. In other words, the UE 115 may use the first signaling restriction set for the first subset of DTX/DRX configurations with non-active periods having durations less than the threshold and the second signaling restriction set for the second subset of DTX/DRX configurations with non-active periods having durations less than or equal to the threshold.

In some other examples, the network entity 105 may indicate multiple non-active duration thresholds. In such examples, the first signaling restriction set may correspond to a first subset of cell DTX/DRX configurations, each cell DTX/DRX configuration of the first subset of cell DTX/DRX configurations being associated with a respective first DTX/DRX cycle having a non-active period with a duration less than or equal to a first non-active duration threshold. A second signaling restriction set may correspond to a second subset of cell DTX/DRX configurations, each cell DTX/DRX configuration of the second subset of cell DTX/DRX configurations being associated with a respective second DTX/DRX cycle having a non-active period with a duration greater than the first non-active duration threshold and less than or equal to a second non-active duration threshold. A third signaling restriction set may correspond to a third subset of cell DTX/DRX configurations, each cell DTX/DRX configuration of the third subset of cell DTX/DRX configurations being associated with a respective third DTX/DRX cycle having a non-active period with a duration greater than the second non-active duration threshold. In other words, the UE 115 may use the first signaling restriction set, the second signaling restriction set, or the third signaling restriction set in accordance with comparing durations of non-active periods of cell DTX/DRX cycles to the multiple thresholds.

In some aspects, the signaling restriction sets may include greater quantities of signaling restrictions with respect to the duration of the inactive time associated with the cell DTX/DTX cycles. For example, the second signaling restriction set may include a relatively smaller quantity of signaling restrictions relative to the first signaling restriction set, and the third signaling restriction set may include a relatively smaller quantity of signaling restrictions relative to the second signaling restriction set. Additionally, or alternatively, the second signaling restriction set may include relatively less severe restrictions relative to the first signaling restriction set, and the third signaling restriction set may include relatively less severe restrictions relative to the second signaling restriction set. As an example, a severity of a signaling restriction set may relate to a priority of signals and/or channels that are restricted. For example, a relatively more severe signaling restriction set may restrict a relatively higher priority signal or channel that is not restricted by a relatively less severe signaling restriction set, even though both signaling restriction sets may restrict a same quantity of signals and/or channels.

At 525, the network entity 105 may transmit an indication of one or more active duration thresholds to the UE 115. For example, the network entity 105 may transmit the indication of the one or more active duration thresholds to be used with, or separately from, the indication of the one or more non-active duration thresholds. In other words, the UE 115 may apply a signaling restriction set in accordance with comparing a duration of a non-active period and/or an active period of an activated cell DTX/DRX cycle to the one or more non-active duration thresholds and/or the one or more active duration thresholds (as described with reference to FIGS. 3A and 3B).

For example, a first signaling restriction set may correspond to a first subset of cell DTX/DRX configurations. Each cell DTX/DRX configuration of the first subset of cell DTX/DRX configurations is associated with a respective first DTX/DRX cycle having a non-active period with a duration less than or equal to a shortest non-active duration threshold and active periods with durations less than or equal to a shortest active duration threshold. A second signaling restriction set may correspond to a second subset of cell DTX/DRX configurations. Each cell DTX/DRX configuration of the second subset of cell DTX/DRX configurations is associated with a respective second DTX/DRX cycle having a non-active period with a duration greater than or equal to a longest non-active duration threshold and active periods with durations greater than or equal to a longest active duration threshold. In other words, the UE 115 may use the first signaling restriction set, the second signaling restriction set, or signaling restriction sets being between other non-active duration and active duration thresholds in accordance with comparing durations of non-active periods and active periods of cell DTX/DRX cycles to the multiple non-active duration thresholds and active duration thresholds.

In some aspects, the signaling restriction sets may include relatively greater quantities of signaling restrictions (or more severe signaling restrictions) with respect to the duration of the inactive time and active time associated with the cell DTX/DTX cycles. For example, the second signaling restriction set may include a relatively smaller (such as a smallest) quantity of signaling restrictions (or relatively less, or least, severe signaling restrictions) relative to the other signaling restriction sets, and the first signaling restriction set may include a relatively greater (such as a greatest) quantity of signaling restrictions (or relatively more, or most, severe signaling restrictions) relative to the other signaling restriction sets.

At 530, the network entity 105 may transmit an indication of a mapping between the cell DTX/DRX configurations and the signaling restriction sets to the UE 115. For example, the network entity 105 may indicate, to the UE 115 which signaling restriction sets are to be applied to respective cell DTX/DRX configurations.

At 535, the network entity 105 may transmit an indication of a criteria to the UE 115. For example, the criteria may include a latency tolerance of the UE 115, a power level of the UE 115, or both. In some aspects, the network entity 105 may transmit the indication via an RRC message. Additionally, or alternatively, the UE 115 may retrieve the criteria from a memory of the UE 115.

At 540, the network entity 105 may transmit an indication of a periodic configuration to the UE 115. For example, the periodic configuration may be associated with two or more signaling restriction sets. The UE 115 may apply the two or more signaling restriction sets to the non-active period of a DTX/DRX cycle periodically. In other words, the UE 115 may use a first signaling restriction set for a first occurrence of a non-active period, a second signaling restriction set for a second occurrence of a non-active period, and so on. That is, the UE 115 may apply the first signaling restriction set to odd occurrences of the non-active period and the second signaling restriction set to odd occurrences of the non-active period.

At 545, the network entity 105 may transmit a cell DTX/DRX activation or deactivation message to the UE 115. For example, the network entity 105 may transmit a DCI activating a cell DTX/DRX configuration. Additionally, or alternatively, the DCI may include information indicative of whether the UE 115 is expected to operate in accordance with a C-DRX configuration at the UE 115 or a cell DTX/DRX configuration (such as described with reference to FIG. 4A). In some aspects, the DCI may include information indicative of a spatial or power adaptation state associated with the serving cell.

In some examples, the cell DTX/DRX activation or deactivation message may include an indication of a signaling restriction set to be used by the UE 115. For example, the indication of the signaling restriction set may include a quantity of bits. Different permutations of the quantity of bits may indicate different signaling restriction sets. In other words, bits of the DCI may point to an index (such as previously indicated to the UE 115 via an RRC message) associated with a signaling restriction set. The indication of the signaling restriction set via DCI may be described in greater detail elsewhere herein, including with reference to FIG. 4A.

At 550, the UE 115 may select a signaling restriction set. For example, the UE 115 may select a signaling restriction set to use for communication in accordance with receiving the non-active duration thresholds at 520, the active duration thresholds at 525, the indication of mapping at 530, the criteria at 535, the periodic configuration at 540, the cell DTX/DRX activation or deactivation message at 545, or any combination thereof. In other words, the UE 115 may select the signaling restriction set in accordance with receiving the signaling restriction sets at 515 and one or more additional indications from the network entity 105.

For example, the UE 115 may select the signaling restriction set in accordance with whether a duration of a non-active period of a DTX/DRX cycle associated with a cell DTX/DRX configuration satisfies one or more non-active duration thresholds, in accordance with whether a duration of an active period of the DTX/DRX cycle associated with the cell DTX/DRX configuration satisfies one or more active duration thresholds, or both. Additionally, or alternatively, the UE 115 may select the signaling restriction set according to the criteria (such as received at 535 or retrieved from a memory of the UE 115).

At 555, the UE 115 may communicate with the serving cell in accordance with the cell DTX/DRX configuration and in accordance with the signaling restriction set associated with the cell DTX/DRX configuration. In other words, the UE 115 may communicate with the network entity 105 according to the activated cell DTX/DRX configuration and the selected and/or indicated signaling restriction set. For example, the UE 115 may transmit one or more signals during a non-active period which are permitted according to the signaling restriction set.

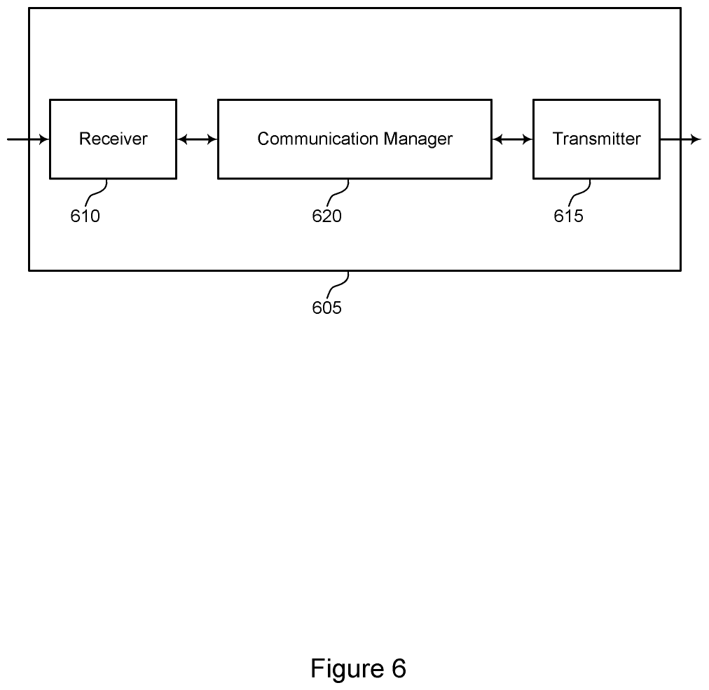

FIG. 6 shows a block diagram of an example device 605 that supports adaptively restricting communication for cell discontinuous operation in accordance with one or more aspects of the present disclosure. The device 605 may be an example of aspects of a UE 115. The device 605 may include a receiver 610, a transmitter 615, and a communication manager 620. The device 605, or one or more components of the device 605 (such as the receiver 610, the transmitter 615, and the communication manager 620), may include at least one processor, which may be coupled with at least one memory, to, individually or collectively, support or enable the described techniques. Each of these components may be in communication with one another (such as via one or more buses).

The receiver 610 may provide a means for receiving information such as packets, user data, control information, or any combination thereof associated with various information channels (such as control channels, data channels, information channels related to adaptively restricting communication for cell discontinuous operation). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (such as control channels, data channels, information channels related to adaptively restricting communication for cell discontinuous operation). In some examples, the transmitter 615 may be co-located with a receiver 610 in a transceiver module. The transmitter 615 may utilize a single antenna or a set of multiple antennas.

The communication manager 620, the receiver 610, the transmitter 615, or various combinations thereof or various components thereof may be examples of means for performing various aspects of adaptively restricting communication for cell discontinuous operation. For example, the communication manager 620, the receiver 610, the transmitter 615, or various combinations or components thereof may be capable of performing one or more of the functions described herein.

In some examples, the communication manager 620, the receiver 610, the transmitter 615, or various combinations or components thereof may be implemented in hardware (such as in communication management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (such as by one or more processors, individually or collectively, executing instructions stored in the at least one memory).

Additionally, or alternatively, the communication manager 620, the receiver 610, the transmitter 615, or various combinations or components thereof may be implemented in code (such as communication management software or firmware) executed by at least one processor. In examples in which the communication manager 620, the receiver 610, the transmitter 615, or various combinations or components thereof are implemented in code executed by at least one processor, the functions of the communication manager 620, the receiver 610, the transmitter 615, or various combinations or components thereof may be performed by a general-purpose processor, a DSP, a CPU, an ASIC, an FPGA, a microcontroller, or any combination of these or other programmable logic devices (such as configured as or otherwise supporting, individually or collectively, a means for performing the functions described in the present disclosure).

In some examples, the communication manager 620 may be configured to perform various operations (such as receiving, obtaining, monitoring, outputting, transmitting) using or otherwise in cooperation with the receiver 610, the transmitter 615, or both. For example, the communication manager 620 may receive information from the receiver 610, send information to the transmitter 615, or be integrated in combination with the receiver 610, the transmitter 615, or both to obtain information, output information, or perform various other operations.

The communication manager 620 may support wireless communication in accordance with examples as disclosed herein. For example, the communication manager 620 is capable of, configured to, or operable to support a means for receiving one or more first control messages including information indicative of a set of multiple cell DTX/DRX configurations associated with a serving cell, each cell DTX/DRX configuration of the set of multiple cell DTX/DRX configurations being associated with a respective DTX/DRX cycle. The communication manager 620 is capable of, configured to, or operable to support a means for receiving one or more second control messages including information indicative of a set of multiple signaling restriction sets, each signaling restriction set of the set of multiple signaling restriction sets being associated with one or more cell DTX/DRX configurations of the set of multiple cell DTX/DRX configurations, each signaling restriction set of the set of multiple signaling restriction sets including one or more respective signaling restrictions associated with communication between the UE and the serving cell over one or more non-active periods of the respective DTX/DRX cycle. The communication manager 620 is capable of, configured to, or operable to support a means for communicating with the serving cell in accordance with a cell DTX/DRX configuration of the set of multiple cell DTX/DRX configurations and in accordance with a signaling restriction set of the set of multiple signaling restriction sets that is associated with the cell DTX/DRX configuration.

By including or configuring the communication manager 620, the device 605 (such as at least one processor controlling or otherwise coupled with the receiver 610, the transmitter 615, the communication manager 620, or a combination thereof) may support techniques for reduced power consumption and more efficient utilization of communication resources.

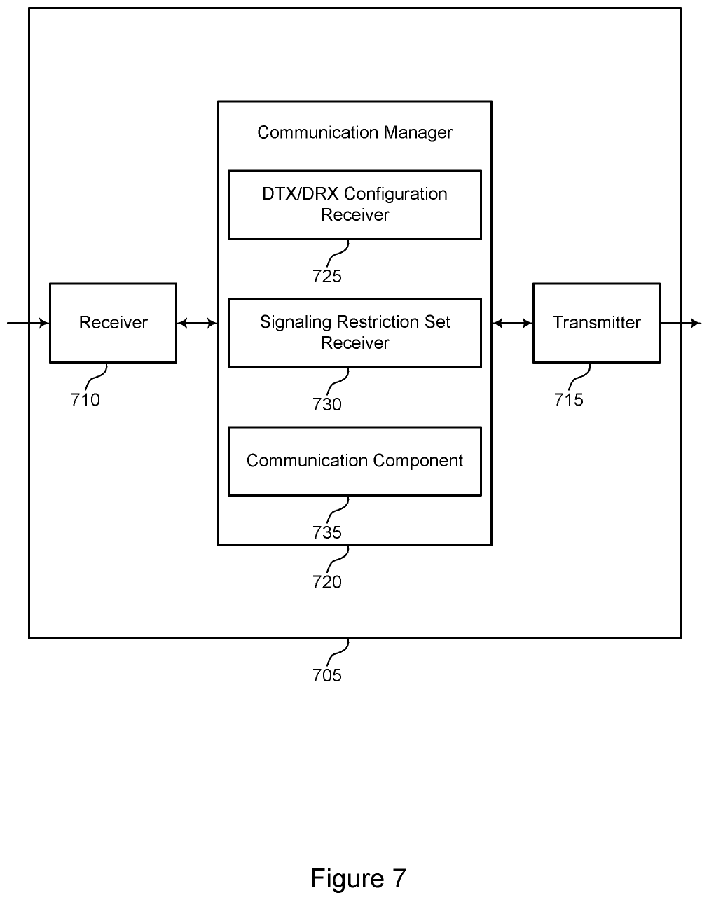

FIG. 7 shows a block diagram of an example device 705 that supports adaptively restricting communication for cell discontinuous operation in accordance with one or more aspects of the present disclosure. The device 705 may be an example of aspects of a device 605 or a UE 115. The device 705 may include a receiver 710, a transmitter 715, and a communication manager 720. The device 705, or one or more components of the device 705 (such as the receiver 710, the transmitter 715, and the communication manager 720), may include at least one processor, which may be coupled with at least one memory, to support the described techniques. Each of these components may be in communication with one another (such as via one or more buses).

The receiver 710 may provide a means for receiving information such as packets, user data, control information, or any combination thereof associated with various information channels (such as control channels, data channels, information channels related to adaptively restricting communication for cell discontinuous operation). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (such as control channels, data channels, information channels related to adaptively restricting communication for cell discontinuous operation). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of adaptively restricting communication for cell discontinuous operation. For example, the communication manager 720 may include a DTX/DRX configuration receiver 725, a signaling restriction set receiver 730, a communication component 735, or any combination thereof. The communication manager 720 may be an example of aspects of a communication manager 620. In some examples, the communication manager 720, or various components thereof, may be configured to perform various operations (such as receiving, obtaining, monitoring, outputting, transmitting) using or otherwise in cooperation with the receiver 710, the transmitter 715, or both. For example, the communication manager 720 may receive information from the receiver 710, send information to the transmitter 715, or be integrated in combination with the receiver 710, the transmitter 715, or both to obtain information, output information, or perform various other operations.

The communication manager 720 may support wireless communication in accordance with examples as disclosed herein. The DTX/DRX configuration receiver 725 is capable of, configured to, or operable to support a means for receiving one or more first control messages including information indicative of a set of multiple cell DTX/DRX configurations associated with a serving cell, each cell DTX/DRX configuration of the set of multiple cell DTX/DRX configurations being associated with a respective DTX/DRX cycle. The signaling restriction set receiver 730 is capable of, configured to, or operable to support a means for receiving one or more second control messages including information indicative of a set of multiple signaling restriction sets, each signaling restriction set of the set of multiple signaling restriction sets being associated with one or more cell DTX/DRX configurations of the set of multiple cell DTX/DRX configurations, each signaling restriction set of the set of multiple signaling restriction sets including one or more respective signaling restrictions associated with communication between the UE and the serving cell over one or more non-active periods of the respective DTX/DRX cycle. The communication component 735 is capable of, configured to, or operable to support a means for communicating with the serving cell in accordance with a cell DTX/DRX configuration of the set of multiple cell DTX/DRX configurations and in accordance with a signaling restriction set of the set of multiple signaling restriction sets that is associated with the cell DTX/DRX configuration.

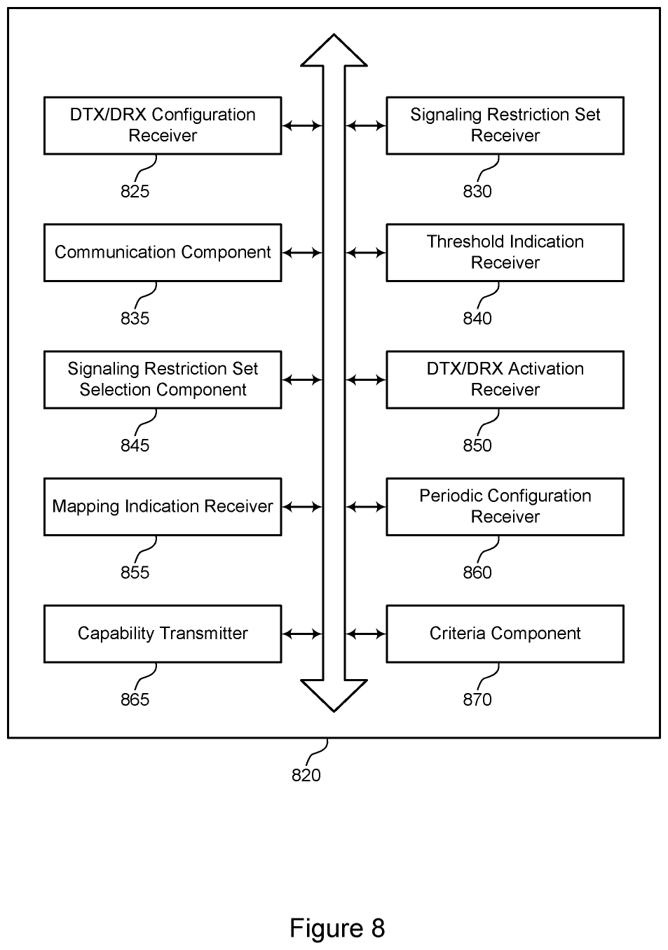

FIG. 8 shows a block diagram of an example communication manager 820 that supports adaptively restricting communication for cell discontinuous operation in accordance with one or more aspects of the present disclosure. The communication manager 820 may be an example of aspects of a communication manager 620, a communication manager 720, or both. The communication manager 820, or various components thereof, may be an example of means for performing various aspects of adaptively restricting communication for cell discontinuous operation. For example, the communication manager 820 may include a DTX/DRX configuration receiver 825, a signaling restriction set receiver 830, a communication component 835, a threshold indication receiver 840, a signaling restriction set selection component 845, a DTX/DRX activation receiver 850, a mapping indication receiver 855, a periodic configuration receiver 860, a capability transmitter 865, a criteria component 870, or any combination thereof. Each of these components, or components or subcomponents thereof (such as one or more processors, one or more memories), may communicate, directly or indirectly, with one another (such as via one or more buses).

The communication manager 820 may support wireless communication in accordance with examples as disclosed herein. The DTX/DRX configuration receiver 825 is capable of, configured to, or operable to support a means for receiving one or more first control messages including information indicative of a set of multiple cell DTX/DRX configurations associated with a serving cell, each cell DTX/DRX configuration of the set of multiple cell DTX/DRX configurations being associated with a respective DTX/DRX cycle. The signaling restriction set receiver 830 is capable of, configured to, or operable to support a means for receiving one or more second control messages including information indicative of a set of multiple signaling restriction sets, each signaling restriction set of the set of multiple signaling restriction sets being associated with one or more cell DTX/DRX configurations of the set of multiple cell DTX/DRX configurations, each signaling restriction set of the set of multiple signaling restriction sets including one or more respective signaling restrictions associated with communication between the UE and the serving cell over one or more non-active periods of the respective DTX/DRX cycle. The communication component 835 is capable of, configured to, or operable to support a means for communicating with the serving cell in accordance with a cell DTX/DRX configuration of the set of multiple cell DTX/DRX configurations and in accordance with a signaling restriction set of the set of multiple signaling restriction sets that is associated with the cell DTX/DRX configuration.

In some examples, the threshold indication receiver 840 is capable of, configured to, or operable to support a means for receiving an indication of a non-active duration threshold associated with the set of multiple signaling restriction sets. In some examples, the signaling restriction set selection component 845 is capable of, configured to, or operable to support a means for selecting the signaling restriction set in accordance with whether a duration of a non-active period of a DTX/DRX cycle associated with the cell DTX/DRX configuration satisfies the non-active duration threshold.

In some examples, the first signaling restriction set corresponds to a first subset of cell DTX/DRX configurations of the set of multiple cell DTX/DRX configurations, each cell DTX/DRX configuration of the first subset of cell DTX/DRX configurations being associated with a respective first DTX/DRX cycle including first non-active periods of durations greater than the non-active duration threshold. In some examples, the second signaling restriction set corresponds to a second subset of cell DTX/DRX configurations of the set of multiple cell DTX/DRX configurations, each cell DTX/DRX configuration of the second subset of cell DTX/DRX configurations being associated with a respective second DTX/DRX cycle including second non-active periods of durations less than or equal to the non-active duration threshold, the second signaling restriction set including a greater quantity of signaling restrictions relative to the first signaling restriction set.

In some examples, the threshold indication receiver 840 is capable of, configured to, or operable to support a means for receiving an indication of a set of multiple non-active duration thresholds associated with the set of multiple signaling restriction sets. In some examples, the signaling restriction set selection component 845 is capable of, configured to, or operable to support a means for selecting the signaling restriction set in accordance with whether a duration of a non-active period of a DTX/DRX cycle associated with the cell DTX/DRX configuration satisfies one or more of the set of multiple non-active duration thresholds.

In some examples, the first signaling restriction set corresponds to a first subset of cell DTX/DRX configurations of the set of multiple cell DTX/DRX configurations, each cell DTX/DRX configuration of the first subset of cell DTX/DRX configurations being associated with a respective first DTX/DRX cycle including first non-active periods of durations less than or equal to a first non-active duration threshold of the set of multiple non-active duration thresholds. In some examples, the second signaling restriction set corresponds to a second subset of cell DTX/DRX configurations of the set of multiple cell DTX/DRX configurations, each cell DTX/DRX configuration of the second subset of cell DTX/DRX configurations being associated with a respective second DTX/DRX cycle including second non-active periods of durations greater than the first non-active duration threshold and less than or equal to a second non-active duration threshold of the set of multiple non-active duration thresholds, the second signaling restriction set including a smaller quantity of signaling restrictions relative to the first signaling restriction set. In some examples, the third signaling restriction set corresponds to a third subset of cell DTX/DRX configurations of the set of multiple cell DTX/DRX configurations, each cell DTX/DRX configuration of the third subset of cell DTX/DRX configurations being associated with a respective third DTX/DRX cycle including first non-active periods of durations greater than the second non-active duration threshold, the third signaling restriction set including a smaller quantity of signaling restrictions relative to the second signaling restriction set.

In some examples, the threshold indication receiver 840 is capable of, configured to, or operable to support a means for receiving an indication of one or more non-active duration thresholds and one or more active duration thresholds associated with the set of multiple signaling restriction sets. In some examples, the signaling restriction set selection component 845 is capable of, configured to, or operable to support a means for selecting the signaling restriction set in accordance with whether a duration of a non-active period of a DTX/DRX cycle associated with the cell DTX/DRX configuration satisfies one or more of the one or more non-active duration thresholds and in accordance with whether duration of an active period of the DTX/DRX cycle associated with the cell DTX/DRX configuration satisfies one or more of the one or more active duration thresholds.

In some examples, the first signaling restriction set corresponds to a first subset of cell DTX/DRX configurations of the set of multiple cell DTX/DRX configurations, each cell DTX/DRX configuration of the first subset of cell DTX/DRX configurations being associated with a respective first DTX/DRX cycle including first non-active periods of durations less than or equal to a shortest non-active duration threshold of the one or more non-active duration thresholds and first active periods of durations less than or equal to a shortest active duration threshold of the one or more active duration thresholds, the first signaling restriction set including a largest quantity of signaling restrictions. In some examples, the second signaling restriction set corresponds to a second subset of cell DTX/DRX configurations of the set of multiple cell DTX/DRX configurations, each cell DTX/DRX configuration of the second subset of cell DTX/DRX configurations being associated with a respective second DTX/DRX cycle including first non-active periods of durations greater than a longest non-active duration threshold of the one or more non-active duration thresholds and second active periods of durations greater than a longest active duration threshold of the one or more active duration thresholds, the second signaling restriction set including a smallest quantity of signaling restrictions.

In some examples, the DTX/DRX configuration receiver 825 is capable of, configured to, or operable to support a means for receiving the information indicative of the set of multiple signaling restriction sets and the information indicative of the set of multiple cell DTX/DRX configurations via a same set of one or more control messages. Each signaling restriction set of the set of multiple signaling restriction sets is indicated by a respective cell DTX/DRX configuration of the set of multiple cell DTX/DRX configurations. In some examples, the DTX/DRX activation receiver 850 is capable of, configured to, or operable to support a means for receiving a DCI message activating the cell DTX/DRX configuration. Communicating in accordance with the signaling restriction set is in association with the signaling restriction set being indicated by the cell DTX/DRX configuration activated by the DCI message.

In some examples, the mapping indication receiver 855 is capable of, configured to, or operable to support a means for receiving an indication of a mapping between the set of multiple cell DTX/DRX configurations and the set of multiple signaling restriction sets. Communicating in accordance with the cell DTX/DRX configuration and the signaling restriction set is associated with the mapping.

In some examples, the signaling restriction set selection component 845 is capable of, configured to, or operable to support a means for selecting the signaling restriction set in accordance with a criteria. The criteria includes one or more of a latency tolerance of the UE or a power level of the UE. Communicating in accordance with the signaling restriction set is in association with selecting the signaling restriction set in accordance with the criteria.

In some examples, the criteria component 870 is capable of, configured to, or operable to support a means for receiving an indication of the criteria. In some examples, the criteria component 870 is capable of, configured to, or operable to support a means for retrieving the criteria from a memory of the UE.

In some examples, the DTX/DRX activation receiver 850 is capable of, configured to, or operable to support a means for receiving a DCI message activating the cell DTX/DRX configuration. The DCI message includes an indication of the signaling restriction set. Communicating in accordance with the signaling restriction set is in association with the DCI message including the indication of the signaling restriction set.

In some examples, the indication of the signaling restriction set includes a quantity of bits, different permutations of the quantity of bits indicating different signaling restriction sets of the set of multiple signaling restriction sets.

In some examples, the periodic configuration receiver 860 is capable of, configured to, or operable to support a means for receiving information indicative of a periodic configuration associated with two or more signaling restriction sets of the set of multiple signaling restriction sets. In some examples, the communication component 835 is capable of, configured to, or operable to support a means for communicating, during one or more first inactive periods of a DTX/DRX cycle associated with the cell DTX/DRX configuration, in accordance with a first signaling restriction set of the set of multiple signaling restriction sets according to the periodic configuration. In some examples, the communication component 835 is capable of, configured to, or operable to support a means for communicating, during one or more second inactive periods of the DTX/DRX cycle associated with the cell DTX/DRX configuration, in accordance with a second signaling restriction set of the set of multiple signaling restriction sets according to the periodic configuration. The first signaling restriction set and the second signaling restriction set are different.

In some examples, the DTX/DRX activation receiver 850 is capable of, configured to, or operable to support a means for receiving a DCI message activating the cell DTX/DRX configuration. The DCI message includes information indicative of whether the UE is expected to operate in accordance with a connected-mode DRX configuration at the UE or the cell DTX/DRX configuration.

In some examples, the DTX/DRX activation receiver 850 is capable of, configured to, or operable to support a means for receiving a DCI message activating the cell DTX/DRX configuration. The DCI message includes information indicative of a spatial or power adaptation state associated with the serving cell.

In some examples, the capability transmitter 865 is capable of, configured to, or operable to support a means for transmitting an indication of a capability, of the UE, to support the set of multiple signaling restriction sets. Receiving the information indicative of the set of multiple signaling restriction sets is in accordance with the capability of the UE.

In some examples, the one or more first control messages and the one or more second control messages include one or more RRC messages.

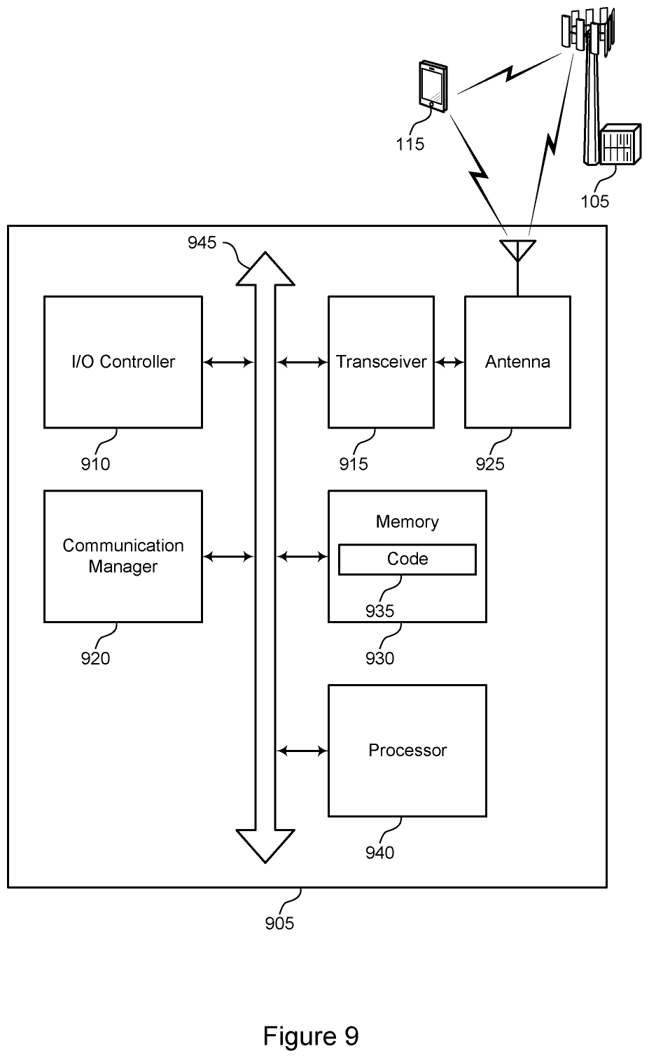

FIG. 9 shows a diagram of a system including an example device 905 that supports adaptively restricting communication for cell discontinuous operation in accordance with one or more aspects of the present disclosure. The device 905 may be an example of or include the components of a device 605, a device 705, or a UE 115. The device 905 may communicate (such as wirelessly) with one or more network entities 105, one or more UEs 115, or any combination thereof. The device 905 may include components for bi-directional voice and data communication including components for transmitting and receiving communication, such as a communication manager 920, an input/output (I/O) controller 910, a transceiver 915, an antenna 925, at least one memory 930, code 935, and at least one processor 940. These components may be in electronic communication or otherwise coupled (such as operatively, communicatively, functionally, electronically, electrically) via one or more buses (such as a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof.

The at least one memory 930 may include random access memory (RAM) and read-only memory (ROM). The at least one memory 930 may store computer-readable, computer-executable code 935 including instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (such as when compiled and executed) to perform functions described herein. In some cases, the at least one memory 930 may contain, among other things, a basic I/O system (BIOS) which may control basic hardware or software operation such as the interaction with peripheral components or devices.

The at least one processor 940 may include an intelligent hardware device (such as a general-purpose processor, a DSP, a CPU, a microcontroller, an ASIC, an FPGA, a programmable logic device, a discrete gate or transistor logic component, a discrete hardware component, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (such as the at least one memory 930) to cause the device 905 to perform various functions (such as functions or tasks supporting adaptively restricting communication for cell discontinuous operation). For example, the device 905 or a component of the device 905 may include at least one processor 940 and at least one memory 930 coupled with or to the at least one processor 940, the at least one processor 940 and at least one memory 930 configured to perform various functions described herein. In some examples, the at least one processor 940 may include multiple processors and the at least one memory 930 may include multiple memories. One or more of the multiple processors may be coupled with one or more of the multiple memories, which may, individually or collectively, be configured to perform various functions herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. As such, the at least one processor 940 or a processing system including the at least one processor 940 may be configured to, configurable to, or operable to cause the device 905 to perform one or more of the functions described herein. Further, being “configured to,” being “configurable to,” and being “operable to” may be used interchangeably and may be associated with a capability, when executing code stored in the at least one memory 930 or otherwise, to perform one or more of the functions described herein.

The communication manager 920 may support wireless communication in accordance with examples as disclosed herein. For example, the communication manager 920 is capable of, configured to, or operable to support a means for receiving one or more first control messages including information indicative of a set of multiple cell DTX/DRX configurations associated with a serving cell, each cell DTX/DRX configuration of the set of multiple cell DTX/DRX configurations being associated with a respective DTX/DRX cycle. The communication manager 920 is capable of, configured to, or operable to support a means for receiving one or more second control messages including information indicative of a set of multiple signaling restriction sets, each signaling restriction set of the set of multiple signaling restriction sets being associated with one or more cell DTX/DRX configurations of the set of multiple cell DTX/DRX configurations, each signaling restriction set of the set of multiple signaling restriction sets including one or more respective signaling restrictions associated with communication between the UE and the serving cell over a non-active period of the respective DTX/DRX cycle. The communication manager 920 is capable of, configured to, or operable to support a means for communicating with the serving cell in accordance with a cell DTX/DRX configuration of the set of multiple cell DTX/DRX configurations and in accordance with a signaling restriction set of the set of multiple signaling restriction sets that is associated with the cell DTX/DRX configuration.

By including or configuring the communication manager 920, the device 905 may support techniques for improved communication reliability, reduced power consumption, more efficient utilization of communication resources, improved coordination between devices, and longer battery life.

In some examples, the communication manager 920 may be configured to perform various operations (such as receiving, monitoring, transmitting) using or otherwise in cooperation with the transceiver 915, the one or more antennas 925, or any combination thereof. Although the communication manager 920 is illustrated as a separate component, in some examples, one or more functions described with reference to the communication manager 920 may be supported by or performed by the at least one processor 940, the at least one memory 930, the code 935, or any combination thereof. For example, the code 935 may include instructions executable by the at least one processor 940 to cause the device 905 to perform various aspects of adaptively restricting communication for cell discontinuous operation, or the at least one processor 940 and the at least one memory 930 may be otherwise configured to, individually or collectively, perform or support such operations.

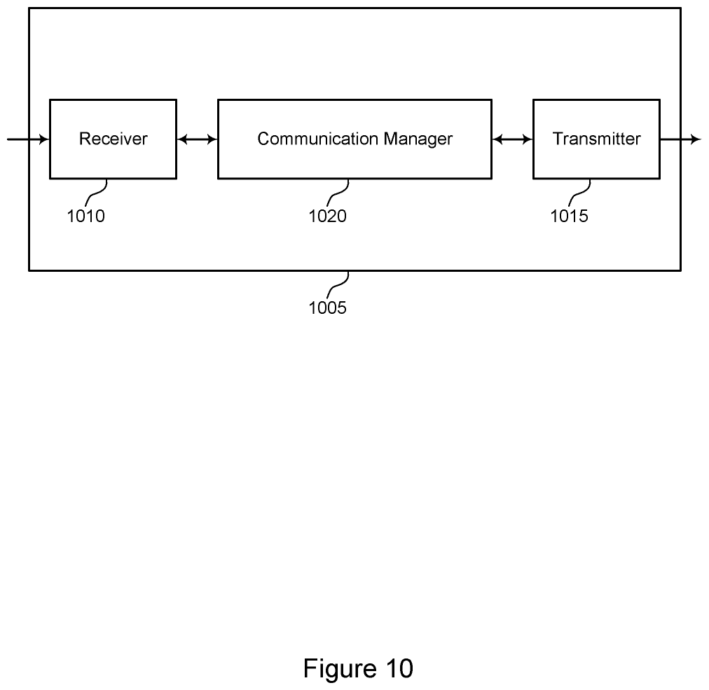

FIG. 10 shows a block diagram of an example device 1005 that supports adaptively restricting communication for cell discontinuous operation in accordance with one or more aspects of the present disclosure. The device 1005 may be an example of aspects of a network entity 105. The device 1005 may include a receiver 1010, a transmitter 1015, and a communication manager 1020. The device 1005, or one or more components of the device 1005 (such as the receiver 1010, the transmitter 1015, and the communication manager 1020), may include at least one processor, which may be coupled with at least one memory, to, individually or collectively, support or enable the described techniques. Each of these components may be in communication with one another (such as via one or more buses).

The receiver 1010 may provide a means for obtaining (such as receiving, determining, identifying) information such as user data, control information, or any combination thereof (such as I/Q samples, symbols, packets, protocol data units, service data units) associated with various channels (such as control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (such as electrical, fiber optic) interfaces, wireless interfaces, or any combination thereof.

The transmitter 1015 may provide a means for outputting (such as transmitting, providing, conveying, sending) information generated by other components of the device 1005. For example, the transmitter 1015 may output information such as user data, control information, or any combination thereof (such as I/Q samples, symbols, packets, protocol data units, service data units) associated with various channels (such as control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (such as electrical, fiber optic) interfaces, wireless interfaces, or any combination thereof. In some examples, the transmitter 1015 and the receiver 1010 may be co-located in a transceiver, which may include or be coupled with a modem.

The communication manager 1020, the receiver 1010, the transmitter 1015, or various combinations thereof or various components thereof may be examples of means for performing various aspects of adaptively restricting communication for cell discontinuous operation. For example, the communication manager 1020, the receiver 1010, the transmitter 1015, or various combinations or components thereof may be capable of performing one or more of the functions described herein.

In some examples, the communication manager 1020, the receiver 1010, the transmitter 1015, or various combinations or components thereof may be implemented in hardware (such as in communication management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (such as by one or more processors, individually or collectively, executing instructions stored in the at least one memory).

Additionally, or alternatively, the communication manager 1020, the receiver 1010, the transmitter 1015, or various combinations or components thereof may be implemented in code (such as communication management software or firmware) executed by at least one processor. In examples in which the communication manager 1020, the receiver 1010, the transmitter 1015, or various combinations or components thereof are implemented in code executed by at least one processor, the functions of the communication manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (such as configured as or otherwise supporting, individually or collectively, a means for performing the functions described in the present disclosure).

In some examples, the communication manager 1020 may be configured to perform various operations (such as receiving, obtaining, monitoring, outputting, transmitting) using or otherwise in cooperation with the receiver 1010, the transmitter 1015, or both. For example, the communication manager 1020 may receive information from the receiver 1010, send information to the transmitter 1015, or be integrated in combination with the receiver 1010, the transmitter 1015, or both to obtain information, output information, or perform various other operations.

The communication manager 1020 may support wireless communication in accordance with examples as disclosed herein. For example, the communication manager 1020 is capable of, configured to, or operable to support a means for transmitting, to a UE, one or more first control messages including information indicative of a set of multiple DTX/DRX configurations associated with a serving cell, each cell DTX/DRX configuration of the set of multiple cell DTX/DRX configurations being associated with a respective DTX/DRX cycle. The communication manager 1020 is capable of, configured to, or operable to support a means for transmitting one or more second control messages including information indicative of a set of multiple signaling restriction sets, each signaling restriction set of the set of multiple signaling restriction sets being associated with one or more cell DTX/DRX configurations of the set of multiple cell DTX/DRX configurations, each signaling restriction set of the set of multiple signaling restriction sets including one or more respective signaling restrictions associated with communication between the UE and the serving cell over a non-active period of the respective DTX/DRX cycle. The communication manager 1020 is capable of, configured to, or operable to support a means for communicating with the UE via the serving cell in accordance with a cell DTX/DRX configuration of the set of multiple cell DTX/DRX configurations and in accordance with a signaling restriction set of the set of multiple signaling restriction sets that is associated with the cell DTX/DRX configuration.

By including or configuring the communication manager 1020, the device 1005 (such as at least one processor controlling or otherwise coupled with the receiver 1010, the transmitter 1015, the communication manager 1020, or a combination thereof) may support techniques for reduced power consumption and more efficient utilization of communication resources.

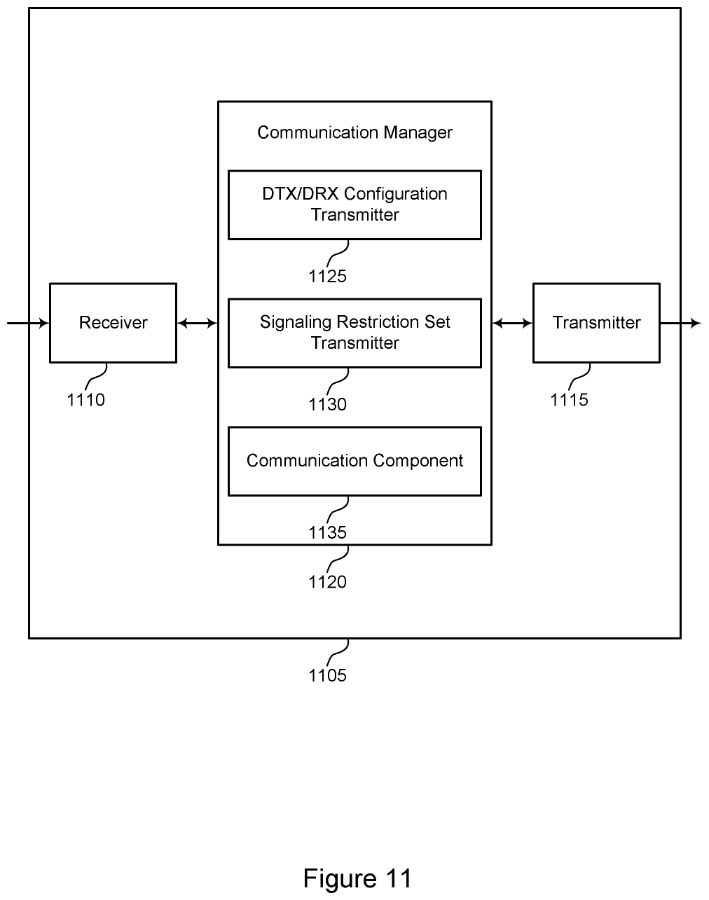

FIG. 11 shows a block diagram of an example device 1105 that supports adaptively restricting communication for cell discontinuous operation in accordance with one or more aspects of the present disclosure. The device 1105 may be an example of aspects of a device 1005 or a network entity 105. The device 1105 may include a receiver 1110, a transmitter 1115, and a communication manager 1120. The device 1105, or one or more components of the device 1105 (such as the receiver 1110, the transmitter 1115, and the communication manager 1120), may include at least one processor, which may be coupled with at least one memory, to support the described techniques. Each of these components may be in communication with one another (such as via one or more buses).

The receiver 1110 may provide a means for obtaining (such as receiving, determining, identifying) information such as user data, control information, or any combination thereof (such as I/Q samples, symbols, packets, protocol data units, service data units) associated with various channels (such as control channels, data channels, information channels, channels associated with a protocol stack). Information may be passed onto other components of the device 1105. In some examples, the receiver 1110 may support obtaining information by receiving signals via one or more antennas. Additionally, or alternatively, the receiver 1110 may support obtaining information by receiving signals via one or more wired (such as electrical, fiber optic) interfaces, wireless interfaces, or any combination thereof.

The transmitter 1115 may provide a means for outputting (such as transmitting, providing, conveying, sending) information generated by other components of the device 1105. For example, the transmitter 1115 may output information such as user data, control information, or any combination thereof (such as I/Q samples, symbols, packets, protocol data units, service data units) associated with various channels (such as control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (such as electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of adaptively restricting communication for cell discontinuous operation. For example, the communication manager 1120 may include a DTX/DRX configuration transmitter 1125, a signaling restriction set transmitter 1130, a communication component 1135, or any combination thereof. The communication manager 1120 may be an example of aspects of a communication manager 1020. In some examples, the communication manager 1120, or various components thereof, may be configured to perform various operations (such as receiving, obtaining, monitoring, outputting, transmitting) using or otherwise in cooperation with the receiver 1110, the transmitter 1115, or both. For example, the communication manager 1120 may receive information from the receiver 1110, send information to the transmitter 1115, or be integrated in combination with the receiver 1110, the transmitter 1115, or both to obtain information, output information, or perform various other operations.

The communication manager 1120 may support wireless communication in accordance with examples as disclosed herein. The DTX/DRX configuration transmitter 1125 is capable of, configured to, or operable to support a means for transmitting, to a UE, one or more first control messages including information indicative of a set of multiple DTX/DRX configurations associated with a serving cell, each cell DTX/DRX configuration of the set of multiple cell DTX/DRX configurations being associated with a respective DTX/DRX cycle. The signaling restriction set transmitter 1130 is capable of, configured to, or operable to support a means for transmitting one or more second control messages including information indicative of a set of multiple signaling restriction sets, each signaling restriction set of the set of multiple signaling restriction sets being associated with one or more cell DTX/DRX configurations of the set of multiple cell DTX/DRX configurations, each signaling restriction set of the set of multiple signaling restriction sets including one or more respective signaling restrictions associated with communication between the UE and the serving cell over a non-active period of the respective DTX/DRX cycle. The communication component 1135 is capable of, configured to, or operable to support a means for communicating with the UE via the serving cell in accordance with a cell DTX/DRX configuration of the set of multiple cell DTX/DRX configurations and in accordance with a signaling restriction set of the set of multiple signaling restriction sets that is associated with the cell DTX/DRX configuration.

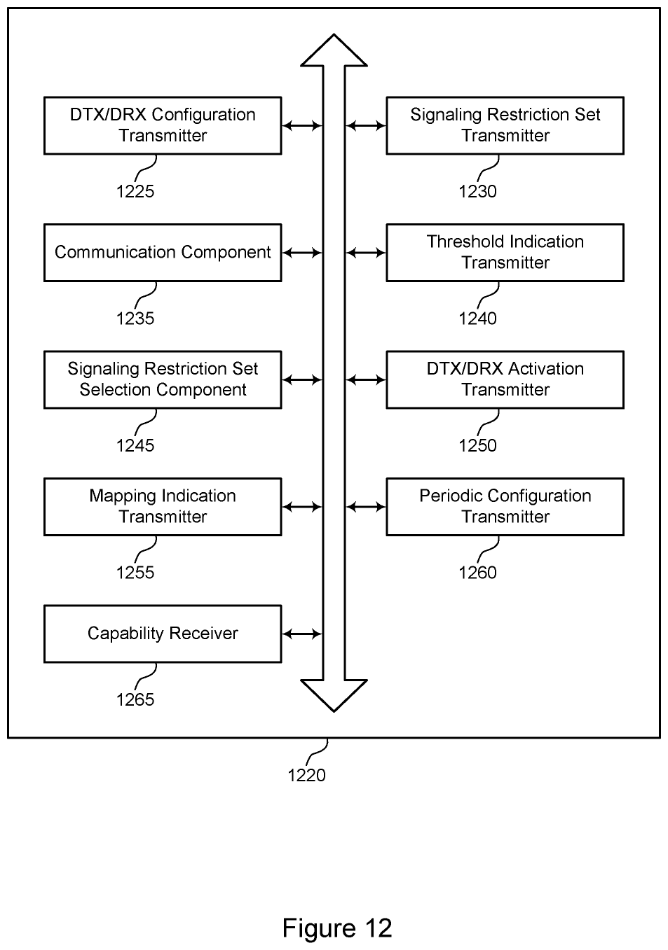

FIG. 12 shows a block diagram of an example communication manager 1220 that supports adaptively restricting communication for cell discontinuous operation in accordance with one or more aspects of the present disclosure. The communication manager 1220 may be an example of aspects of a communication manager 1020, a communication manager 1120, or both. The communication manager 1220, or various components thereof, may be an example of means for performing various aspects of adaptively restricting communication for cell discontinuous operation. For example, the communication manager 1220 may include a DTX/DRX configuration transmitter 1225, a signaling restriction set transmitter 1230, a communication component 1235, a threshold indication transmitter 1240, a signaling restriction set selection component 1245, a DTX/DRX activation transmitter 1250, a mapping indication transmitter 1255, a periodic configuration transmitter 1260, a capability receiver 1265, or any combination thereof. Each of these components, or components or subcomponents thereof (such as one or more processors, one or more memories), may communicate, directly or indirectly, with one another (such as via one or more buses) which may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

The communication manager 1220 may support wireless communication in accordance with examples as disclosed herein. The DTX/DRX configuration transmitter 1225 is capable of, configured to, or operable to support a means for transmitting, to a UE, one or more first control messages including information indicative of a set of multiple DTX/DRX configurations associated with a serving cell, each cell DTX/DRX configuration of the set of multiple cell DTX/DRX configurations being associated with a respective DTX/DRX cycle. The signaling restriction set transmitter 1230 is capable of, configured to, or operable to support a means for transmitting one or more second control messages including information indicative of a set of multiple signaling restriction sets, each signaling restriction set of the set of multiple signaling restriction sets being associated with one or more cell DTX/DRX configurations of the set of multiple cell DTX/DRX configurations, each signaling restriction set of the set of multiple signaling restriction sets including one or more respective signaling restrictions associated with communication between the UE and the serving cell over a non-active period of the respective DTX/DRX cycle. The communication component 1235 is capable of, configured to, or operable to support a means for communicating with the UE via the serving cell in accordance with a cell DTX/DRX configuration of the set of multiple cell DTX/DRX configurations and in accordance with a signaling restriction set of the set of multiple signaling restriction sets that is associated with the cell DTX/DRX configuration.

In some examples, the threshold indication transmitter 1240 is capable of, configured to, or operable to support a means for transmitting an indication of a non-active duration threshold associated with the set of multiple signaling restriction sets. In some examples, the signaling restriction set selection component 1245 is capable of, configured to, or operable to support a means for selecting the signaling restriction set in accordance with whether a non-active duration of a DTX/DRX cycle associated with the cell DTX/DRX configuration satisfies the non-active duration threshold.

In some examples, the first signaling restriction set corresponds to a first subset of cell DTX/DRX configurations of the set of multiple cell DTX/DRX configurations, each cell DTX/DRX configuration of the first subset of cell DTX/DRX configurations being associated with a respective first DTX/DRX cycle having a non-active duration greater than the non-active duration threshold. In some examples, the second signaling restriction set corresponds to a second subset of cell DTX/DRX configurations of the set of multiple cell DTX/DRX configurations each cell DTX/DRX configuration of the second subset of cell DTX/DRX configurations being associated with a respective second DTX/DRX cycle having a non-active duration less than or equal to the non-active duration threshold, the second signaling restriction set including a greater quantity of signaling restrictions relative to the first signaling restriction set.

In some examples, the threshold indication transmitter 1240 is capable of, configured to, or operable to support a means for transmitting an indication of a set of multiple non-active duration thresholds associated with the set of multiple signaling restriction sets. In some examples, the signaling restriction set selection component 1245 is capable of, configured to, or operable to support a means for selecting the signaling restriction set in accordance with whether a non-active duration of a DTX/DRX cycle associated with the cell DTX/DRX cycle satisfies one or more of the set of multiple non-active duration thresholds.

In some examples, the first signaling restriction set corresponds to a first subset of cell DTX/DRX configurations of the set of multiple cell DTX/DRX configurations, each cell DTX/DRX configuration of the first subset of cell DTX/DRX configurations being associated with a respective first DTX/DRX cycle having a non-active duration less than or equal to a first non-active duration threshold of the set of multiple non-active duration thresholds. In some examples, the second signaling restriction set corresponds to a second subset of cell DTX/DRX configurations of the set of multiple cell DTX/DRX configurations, each cell DTX/DRX configuration of the second subset of cell DTX/DRX configurations being associated with a respective second DTX/DRX cycle having a non-active duration greater than the first non-active duration threshold and less than or equal to a second non-active duration threshold of the set of multiple non-active duration thresholds, the second signaling restriction set including a smaller quantity of signaling restrictions relative to the first signaling restriction set. In some examples, the third signaling restriction set corresponds to a third subset of cell DTX/DRX configurations of the set of multiple cell DTX/DRX configurations, each cell DTX/DRX configuration of the third subset of cell DTX/DRX configurations being associated with a respective third DTX/DRX cycle having a non-active duration greater than the second non-active duration threshold, the third signaling restriction set including a smaller quantity of signaling restrictions relative to the second signaling restriction set.

In some examples, the threshold indication transmitter 1240 is capable of, configured to, or operable to support a means for transmitting an indication of one or more non-active duration thresholds and one or more active duration thresholds associated with the set of multiple signaling restriction sets. In some examples, the signaling restriction set selection component 1245 is capable of, configured to, or operable to support a means for selecting the signaling restriction set in accordance with whether a non-active duration of a DTX/DRX cycle associated with the cell DTX/DRX configuration satisfies one or more of the one or more non-active duration thresholds and in accordance with whether an active duration of the DTX/DRX cycle associated with the cell DTX/DRX configuration satisfies one or more of the one or more active duration thresholds.

In some examples, the first signaling restriction set corresponds to a first subset of cell DTX/DRX configurations of the set of multiple cell DTX/DRX configurations, each cell DTX/DRX configuration of the first subset of cell DTX/DRX configurations being associated with a respective first DTX/DRX cycle having a non-active duration less than or equal to a shortest non-active duration threshold of the one or more non-active duration thresholds and active durations less than or equal to a shortest active duration threshold of the one or more active duration thresholds, the first signaling restriction set including a largest quantity of signaling restrictions. In some examples, the second signaling restriction set corresponds to a second subset of cell DTX/DRX configurations of the set of multiple cell DTX/DRX configurations, each cell DTX/DRX configuration of the second subset of cell DTX/DRX configurations being associated with a respective second DTX/DRX cycle having a non-active duration greater than a longest non-active duration threshold of the one or more non-active duration thresholds and active durations greater than a longest active duration threshold of the one or more active duration thresholds, the second signaling restriction set including a smallest quantity of signaling restrictions.

In some examples, the DTX/DRX configuration transmitter 1225 is capable of, configured to, or operable to support a means for transmitting the information indicative of the set of multiple signaling restriction sets and the information indicative of the set of multiple cell DTX/DRX configurations via a same set of one or more control messages. Each signaling restriction set of the set of multiple signaling restriction sets is indicated by a respective cell DTX/DRX configuration of the set of multiple cell DTX/DRX configurations. In some examples, the DTX/DRX activation transmitter 1250 is capable of, configured to, or operable to support a means for transmitting a DCI message activating the cell DTX/DRX configuration. Communicating in accordance with the signaling restriction set is in association with the signaling restriction set being indicated by the cell DTX/DRX configuration activated by the DCI message.

In some examples, the mapping indication transmitter 1255 is capable of, configured to, or operable to support a means for transmitting an indication of a mapping between the set of multiple cell DTX/DRX configurations and the set of multiple signaling restriction sets. Communicating in accordance with the cell DTX/DRX configuration and the signaling restriction set is associated with the mapping.

In some examples, the DTX/DRX activation transmitter 1250 is capable of, configured to, or operable to support a means for transmitting a DCI message activating the cell DTX/DRX configuration. The DCI message includes an indication of the signaling restriction set. Communicating in accordance with the signaling restriction set is in association with the DCI message including the indication of the signaling restriction set.

In some examples, the indication of the signaling restriction set includes a quantity of bits, different permutations of the quantity of bits indicating different signaling restriction sets of the set of multiple signaling restriction sets.

In some examples, the periodic configuration transmitter 1260 is capable of, configured to, or operable to support a means for transmitting information indicative of a periodic configuration associated with two or more signaling restriction sets of the set of multiple signaling restriction sets. In some examples, the communication component 1235 is capable of, configured to, or operable to support a means for communicating, during one or more first inactive periods of a DTX/DRX cycle associated with the cell DTX/DRX configuration, in accordance with a first signaling restriction set of the set of multiple signaling restriction sets according to the periodic configuration. In some examples, the communication component 1235 is capable of, configured to, or operable to support a means for communicating, during one or more second inactive periods of the DTX/DRX cycle, in accordance with a second signaling restriction set of the set of multiple signaling restriction sets according to the periodic configuration. The first signaling restriction set and the second signaling restriction set are different.

In some examples, the DTX/DRX activation transmitter 1250 is capable of, configured to, or operable to support a means for transmitting a DCI message activating the cell DTX/DRX configuration. The DCI message includes information indicative of whether the UE is expected to operate in accordance with a connected-mode DRX configuration at the UE or the cell DTX/DRX configuration.

In some examples, the DTX/DRX activation transmitter 1250 is capable of, configured to, or operable to support a means for transmitting a DCI message activating the cell DTX/DRX configuration. The DCI message includes information indicative of a spatial or power adaptation state associated with the serving cell.

In some examples, the capability receiver 1265 is capable of, configured to, or operable to support a means for receiving an indication of a capability, of the UE, to support the set of multiple signaling restriction sets. Transmitting the information indicative of the set of multiple signaling restriction sets is in accordance with the capability of the UE.

In some examples, the one or more first control messages and the one or more second control messages include one or more RRC messages.

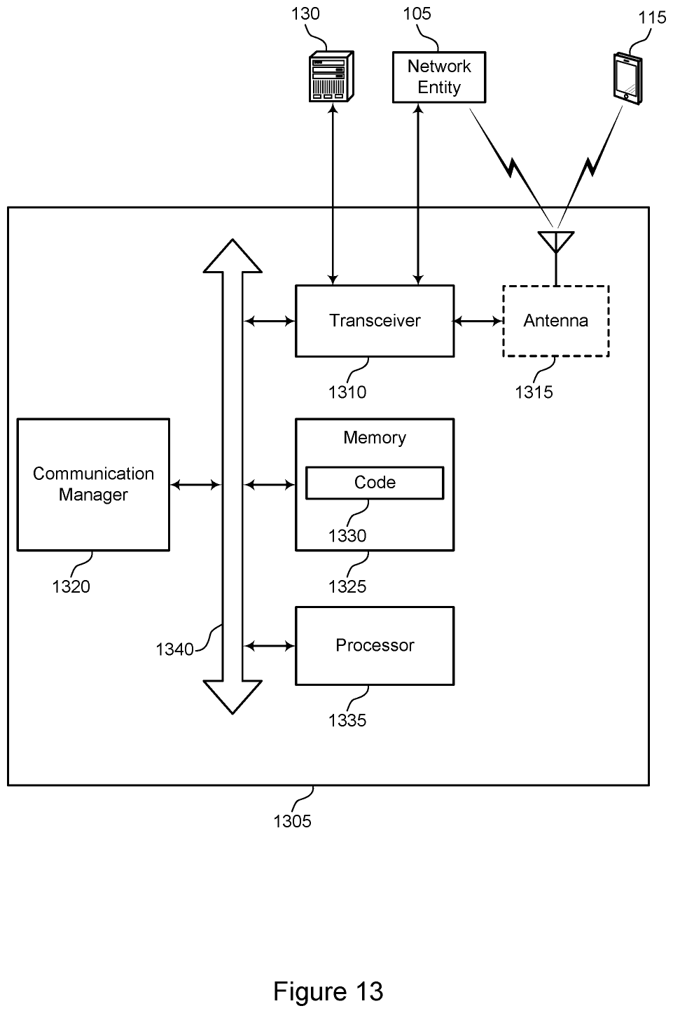

FIG. 13 shows a diagram of a system including an example device 1305 that supports adaptively restricting communication for cell discontinuous operation in accordance with one or more aspects of the present disclosure. The device 1305 may be an example of or include the components of a device 1005, a device 1105, or a network entity 105. The device 1305 may communicate with one or more network entities 105, one or more UEs 115, or any combination thereof, which may include communication over one or more wired interfaces, over one or more wireless interfaces, or any combination thereof. The device 1305 may include components that support outputting and obtaining communication, such as a communication manager 1320, a transceiver 1310, an antenna 1315, at least one memory 1325, code 1330, and at least one processor 1335. These components may be in electronic communication or otherwise coupled (such as operatively, communicatively, functionally, electronically, electrically) via one or more buses (such as a bus 1340).

The transceiver 1310 may support bi-directional communication via wired links, wireless links, or both. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (such as concurrently). The transceiver 1310 may also include a modem to modulate signals, to provide the modulated signals for transmission (such as by one or more antennas 1315, by a wired transmitter), to receive modulated signals (such as from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (such as the at least one processor 1335, the at least one memory 1325, or both), may be included in a chip or chip assembly that is installed in the device 1305. In some examples, the transceiver 1310 may be operable to support communication via one or more communication links (such as a communication link 125, a backhaul communication link 120, a midhaul communication link 162, a fronthaul communication link 168).

The at least one memory 1325 may include RAM, ROM, or any combination thereof. The at least one memory 1325 may store computer-readable, computer-executable code 1330 including instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (such as when compiled and executed) to perform functions described herein. In some cases, the at least one memory 1325 may contain, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include an intelligent hardware device (such as a general-purpose processor, a DSP, an ASIC, a CPU, an FPGA, a microcontroller, a programmable logic device, discrete gate or transistor logic, a discrete hardware component, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (such as one or more of the at least one memory 1325) to cause the device 1305 to perform various functions (such as functions or tasks supporting adaptively restricting communication for cell discontinuous operation). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (such as one or more physical nodes and supporting software such as operating systems, virtual machines, or container instances) that may host the functions (such as by executing code 1330) to perform the functions of the device 1305. The at least one processor 1335 may be any one or more suitable processors capable of executing scripts or instructions of one or more software programs stored in the device 1305 (such as within one or more of the at least one memory 1325). In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. As such, the at least one processor 1335 or a processing system including the at least one processor 1335 may be configured to, configurable to, or operable to cause the device 1305 to perform one or more of the functions described herein. Further, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communication of (such as within) a protocol layer of a protocol stack. In some examples, a bus 1340 may support communication associated with a logical channel of a protocol stack (such as between protocol layers of a protocol stack), which may include communication performed within a component of the device 1305, or between different components of the device 1305 that may be co-located or located in different locations (such as the device 1305 may refer to a system in which one or more of the communication manager 1320, the transceiver 1310, the at least one memory 1325, the code 1330, and the at least one processor 1335 may be located in one of the different components or divided between different components).

In some examples, the communication manager 1320 may manage aspects of communication with a core network 130 (such as via one or more wired or wireless backhaul links). For example, the communication manager 1320 may manage the transfer of data communication for client devices, such as one or more UEs 115. In some examples, the communication manager 1320 may manage communication with other network entities 105, and may include a controller or scheduler for controlling communication with UEs 115 in cooperation with other network entities 105. In some examples, the communication manager 1320 may support an X2 interface within an LTE/LTE-A wireless communication network technology to provide communication between network entities 105.

The communication manager 1320 may support wireless communication in accordance with examples as disclosed herein. For example, the communication manager 1320 is capable of, configured to, or operable to support a means for transmitting, to a UE, one or more first control messages including information indicative of a set of multiple DTX/DRX configurations associated with a serving cell, each cell DTX/DRX configuration of the set of multiple cell DTX/DRX configurations being associated with a respective DTX/DRX cycle. The communication manager 1320 is capable of, configured to, or operable to support a means for transmitting one or more second control messages including information indicative of a set of multiple signaling restriction sets, each signaling restriction set of the set of multiple signaling restriction sets being associated with one or more cell DTX/DRX configurations of the set of multiple cell DTX/DRX configurations, each signaling restriction set of the set of multiple signaling restriction sets including one or more respective signaling restrictions associated with communication between the UE and the serving cell over one or more non-active periods of the respective DTX/DRX cycle. The communication manager 1320 is capable of, configured to, or operable to support a means for communicating with the UE via the serving cell in accordance with a cell DTX/DRX configuration of the set of multiple cell DTX/DRX configurations and in accordance with a signaling restriction set of the set of multiple signaling restriction sets that is associated with the cell DTX/DRX configuration.

By including or configuring the communication manager 1320, the device 1305 may support techniques for improved communication reliability, reduced power consumption, more efficient utilization of communication resources, improved coordination between devices, and longer battery life.

In some examples, the communication manager 1320 may be configured to perform various operations (such as receiving, obtaining, monitoring, outputting, transmitting) using or otherwise in cooperation with the transceiver 1310, the one or more antennas 1315 (as applicable), or any combination thereof. Although the communication manager 1320 is illustrated as a separate component, in some examples, one or more functions described with reference to the communication manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of adaptively restricting communication for cell discontinuous operation, or the at least one processor 1335 and the at least one memory 1325 may be otherwise configured to, individually or collectively, perform or support such operations.

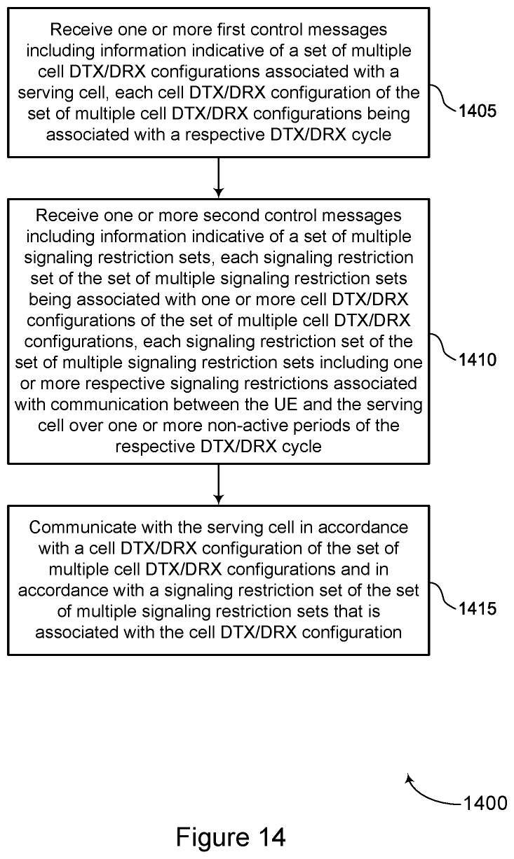

FIG. 14 shows a flowchart illustrating a method 1400 that supports adaptively restricting communication for cell discontinuous operation in accordance with aspects of the present disclosure. The operations of the method 1400 may be implemented by a UE or its components. For example, the operations of the method 1400 may be performed by a UE 115 as described with reference to FIGS. 1-9. In some examples, a UE may execute a set of instructions to control the functional elements of the UE to perform the described functions. Additionally, or alternatively, the UE may perform aspects of the described functions using special-purpose hardware.

At 1405, the method may include receiving one or more first control messages including information indicative of a set of multiple cell DTX/DRX configurations associated with a serving cell, each cell DTX/DRX configuration of the set of multiple cell DTX/DRX configurations being associated with a respective DTX/DRX cycle. The operations of block 1405 may be performed in accordance with examples as disclosed herein. In some examples, aspects of the operations of 1405 may be performed by a DTX/DRX configuration receiver 825 as described with reference to FIG. 8.

At 1410, the method may include receiving one or more second control messages including information indicative of a set of multiple signaling restriction sets, each signaling restriction set of the set of multiple signaling restriction sets being associated with one or more cell DTX/DRX configurations of the set of multiple cell DTX/DRX configurations, each signaling restriction set of the set of multiple signaling restriction sets including one or more respective signaling restrictions associated with communication between the UE and the serving cell over one or more non-active periods of the respective DTX/DRX cycle. The operations of block 1410 may be performed in accordance with examples as disclosed herein. In some examples, aspects of the operations of 1410 may be performed by a signaling restriction set receiver 830 as described with reference to FIG. 8.

At 1415, the method may include communicating with the serving cell in accordance with a cell DTX/DRX configuration of the set of multiple cell DTX/DRX configurations and in accordance with a signaling restriction set of the set of multiple signaling restriction sets that is associated with the cell DTX/DRX configuration. The operations of block 1415 may be performed in accordance with examples as disclosed herein. In some examples, aspects of the operations of 1415 may be performed by a communication component 835 as described with reference to FIG. 8.

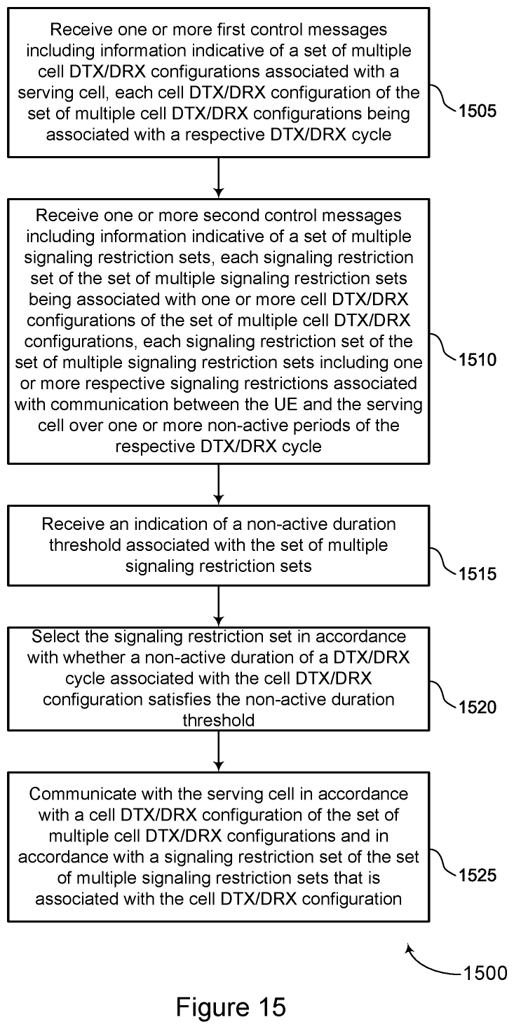

FIG. 15 shows a flowchart illustrating a method 1500 that supports adaptively restricting communication for cell discontinuous operation in accordance with aspects of the present disclosure. The operations of the method 1500 may be implemented by a UE or its components. For example, the operations of the method 1500 may be performed by a UE 115 as described with reference to FIGS. 1-9. In some examples, a UE may execute a set of instructions to control the functional elements of the UE to perform the described functions. Additionally, or alternatively, the UE may perform aspects of the described functions using special-purpose hardware.

At 1505, the method may include receiving one or more first control messages including information indicative of a set of multiple cell DTX/DRX configurations associated with a serving cell, each cell DTX/DRX configuration of the set of multiple cell DTX/DRX configurations being associated with a respective DTX/DRX cycle. The operations of block 1505 may be performed in accordance with examples as disclosed herein. In some examples, aspects of the operations of 1505 may be performed by a DTX/DRX configuration receiver 825 as described with reference to FIG. 8.

At 1510, the method may include receiving one or more second control messages including information indicative of a set of multiple signaling restriction sets, each signaling restriction set of the set of multiple signaling restriction sets being associated with one or more cell DTX/DRX configurations of the set of multiple cell DTX/DRX configurations, each signaling restriction set of the set of multiple signaling restriction sets including one or more respective signaling restrictions associated with communication between the UE and the serving cell over one or more non-active periods of the respective DTX/DRX cycle. The operations of block 1510 may be performed in accordance with examples as disclosed herein. In some examples, aspects of the operations of 1510 may be performed by a signaling restriction set receiver 830 as described with reference to FIG. 8.

At 1515, the method may include receiving an indication of a non-active duration threshold associated with the set of multiple signaling restriction sets. The operations of block 1515 may be performed in accordance with examples as disclosed herein. In some examples, aspects of the operations of 1515 may be performed by a threshold indication receiver 840 as described with reference to FIG. 8.

At 1520, the method may include selecting the signaling restriction set in accordance with whether a duration of a non-active period of a DTX/DRX cycle associated with the cell DTX/DRX configuration satisfies the non-active duration threshold. The operations of block 1520 may be performed in accordance with examples as disclosed herein. In some examples, aspects of the operations of 1520 may be performed by a signaling restriction set selection component 845 as described with reference to FIG. 8.

At 1525, the method may include communicating with the serving cell in accordance with a cell DTX/DRX configuration of the set of multiple cell DTX/DRX configurations and in accordance with a signaling restriction set of the set of multiple signaling restriction sets that is associated with the cell DTX/DRX configuration. The operations of block 1525 may be performed in accordance with examples as disclosed herein. In some examples, aspects of the operations of 1525 may be performed by a communication component 835 as described with reference to FIG. 8.

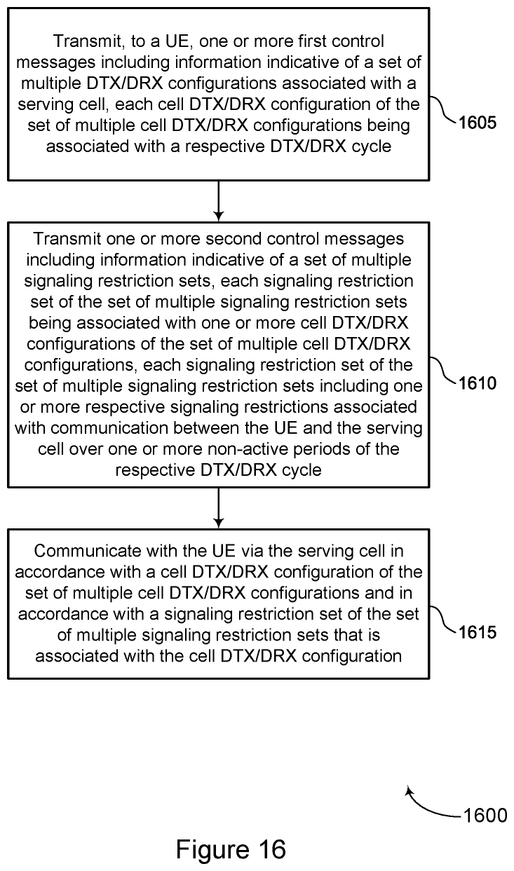

FIG. 16 shows a flowchart illustrating a method 1600 that supports adaptively restricting communication for cell discontinuous operation in accordance with aspects of the present disclosure. The operations of the method 1600 may be implemented by a network entity or its components. For example, the operations of the method 1600 may be performed by a network entity as described with reference to FIGS. 1-5 and 10-13. In some examples, a network entity may execute a set of instructions to control the functional elements of the network entity to perform the described functions. Additionally, or alternatively, the network entity may perform aspects of the described functions using special-purpose hardware.

At 1605, the method may include transmitting, to a UE, one or more first control messages including information indicative of a set of multiple DTX/DRX configurations associated with a serving cell, each cell DTX/DRX configuration of the set of multiple cell DTX/DRX configurations being associated with a respective DTX/DRX cycle. The operations of block 1605 may be performed in accordance with examples as disclosed herein. In some examples, aspects of the operations of 1605 may be performed by a DTX/DRX configuration transmitter 1225 as described with reference to FIG. 12.

At 1610, the method may include transmitting one or more second control messages including information indicative of a set of multiple signaling restriction sets, each signaling restriction set of the set of multiple signaling restriction sets being associated with one or more cell DTX/DRX configurations of the set of multiple cell DTX/DRX configurations, each signaling restriction set of the set of multiple signaling restriction sets including one or more respective signaling restrictions associated with communication between the UE and the serving cell over one or more non-active periods of the respective DTX/DRX cycle. The operations of block 1610 may be performed in accordance with examples as disclosed herein. In some examples, aspects of the operations of 1610 may be performed by a signaling restriction set transmitter 1230 as described with reference to FIG. 12.

At 1615, the method may include communicating with the UE via the serving cell in accordance with a cell DTX/DRX configuration of the set of multiple cell DTX/DRX configurations and in accordance with a signaling restriction set of the set of multiple signaling restriction sets that is associated with the cell DTX/DRX configuration. The operations of block 1615 may be performed in accordance with examples as disclosed herein. In some examples, aspects of the operations of 1615 may be performed by a communication component 1235 as described with reference to FIG. 12.

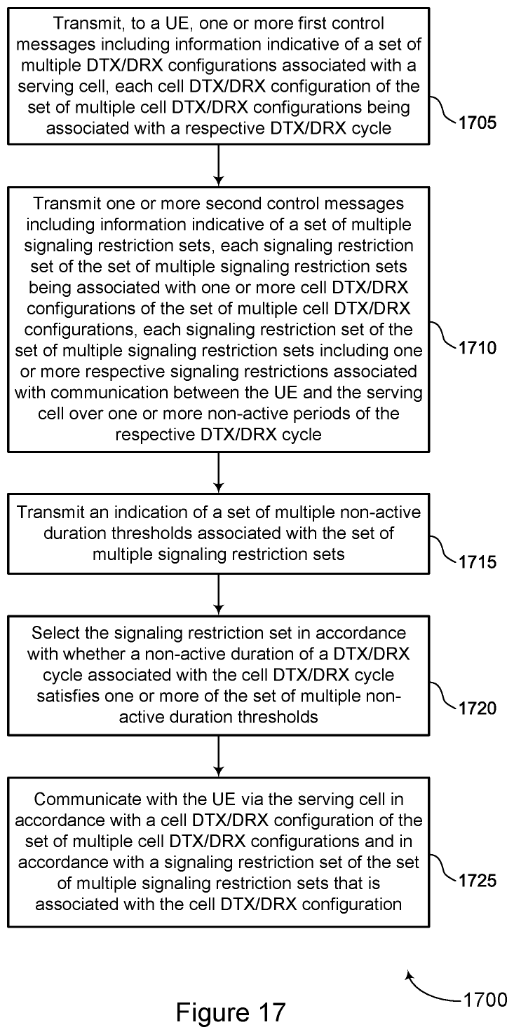

FIG. 17 shows a flowchart illustrating a method 1700 that supports adaptively restricting communication for cell discontinuous operation in accordance with aspects of the present disclosure. The operations of the method 1700 may be implemented by a network entity or its components. For example, the operations of the method 1700 may be performed by a network entity as described with reference to FIGS. 1-5 and 10-13. In some examples, a network entity may execute a set of instructions to control the functional elements of the network entity to perform the described functions. Additionally, or alternatively, the network entity may perform aspects of the described functions using special-purpose hardware.

At 1705, the method may include transmitting, to a UE, one or more first control messages including information indicative of a set of multiple DTX/DRX configurations associated with a serving cell, each cell DTX/DRX configuration of the set of multiple cell DTX/DRX configurations being associated with a respective DTX/DRX cycle. The operations of block 1705 may be performed in accordance with examples as disclosed herein. In some examples, aspects of the operations of 1705 may be performed by a DTX/DRX configuration transmitter 1225 as described with reference to FIG. 12.

At 1710, the method may include transmitting one or more second control messages including information indicative of a set of multiple signaling restriction sets, each signaling restriction set of the set of multiple signaling restriction sets being associated with one or more cell DTX/DRX configurations of the set of multiple cell DTX/DRX configurations, each signaling restriction set of the set of multiple signaling restriction sets including one or more respective signaling restrictions associated with communication between the UE and the serving cell over one or more non-active periods of the respective DTX/DRX cycle. The operations of block 1710 may be performed in accordance with examples as disclosed herein. In some examples, aspects of the operations of 1710 may be performed by a signaling restriction set transmitter 1230 as described with reference to FIG. 12.

At 1715, the method may include transmitting an indication of a set of multiple non-active duration thresholds associated with the set of multiple signaling restriction sets. The operations of block 1715 may be performed in accordance with examples as disclosed herein. In some examples, aspects of the operations of 1715 may be performed by a threshold indication transmitter 1240 as described with reference to FIG. 12.

At 1720, the method may include selecting the signaling restriction set in accordance with whether a non-active duration of a DTX/DRX cycle associated with the cell DTX/DRX cycle satisfies one or more of the set of multiple non-active duration thresholds. The operations of block 1720 may be performed in accordance with examples as disclosed herein. In some examples, aspects of the operations of 1720 may be performed by a signaling restriction set selection component 1245 as described with reference to FIG. 12.

At 1725, the method may include communicating with the UE via the serving cell in accordance with a cell DTX/DRX configuration of the set of multiple cell DTX/DRX configurations and in accordance with a signaling restriction set of the set of multiple signaling restriction sets that is associated with the cell DTX/DRX configuration. The operations of block 1725 may be performed in accordance with examples as disclosed herein. In some examples, aspects of the operations of 1725 may be performed by a communication component 1235 as described with reference to FIG. 12.

The following provides an overview of aspects of the present disclosure:

Aspect 1: A method for wireless communication by a UE, including: receiving one or more first control messages including information indicative of a plurality of cell DTX/DRX configurations associated with a serving cell, each cell DTX/DRX configuration of the plurality of cell DTX/DRX configurations being associated with a respective DTX/DRX cycle; receiving one or more second control messages including information indicative of a plurality of signaling restriction sets, each signaling restriction set of the plurality of signaling restriction sets being associated with one or more cell DTX/DRX configurations of the plurality of cell DTX/DRX configurations, each signaling restriction set of the plurality of signaling restriction sets including one or more respective signaling restrictions associated with communication between the UE and the serving cell over one or more non-active periods of the respective DTX/DRX cycle; and communicating with the serving cell in accordance with a cell DTX/DRX configuration of the plurality of cell DTX/DRX configurations and in accordance with a signaling restriction set of the plurality of signaling restriction sets that is associated with the cell DTX/DRX configuration.

Aspect 2: The method of aspect 1, further including: receiving an indication of a non-active duration threshold associated with the plurality of signaling restriction sets; and selecting the signaling restriction set in accordance with whether a duration of a non-active period of a DTX/DRX cycle associated with the cell DTX/DRX configuration satisfies the non-active duration threshold.

Aspect 3: The method of aspect 2, where the plurality of signaling restriction sets includes at least a first signaling restriction set and a second signaling restriction set, the signaling restriction set being one of the first signaling restriction set or the second signaling restriction set, and where the first signaling restriction set corresponds to a first subset of cell DTX/DRX configurations of the plurality of cell DTX/DRX configurations, each cell DTX/DRX configuration of the first subset of cell DTX/DRX configurations being associated with a respective first DTX/DRX cycle including first non-active periods of durations greater than the non-active duration threshold; and the second signaling restriction set corresponds to a second subset of cell DTX/DRX configurations of the plurality of cell DTX/DRX configurations, each cell DTX/DRX configuration of the second subset of cell DTX/DRX configurations being associated with a respective second DTX/DRX cycle including second non-active periods of durations less than or equal to the non-active duration threshold, the second signaling restriction set including a greater quantity of signaling restrictions relative to the first signaling restriction set.

Aspect 4: The method of any of aspects 1-3, further including: receiving an indication of a plurality of non-active duration thresholds associated with the plurality of signaling restriction sets; and selecting the signaling restriction set in accordance with whether a duration of a non-active period of a DTX/DRX cycle associated with the cell DTX/DRX configuration satisfies one or more of the plurality of non-active duration thresholds.

Aspect 5: The method of aspect 4, where the plurality of signaling restriction sets includes at least a first signaling restriction set, a second signaling restriction set, and a third signaling restriction set, the signaling restriction set being one of the first signaling restriction set, the second signaling restriction set, or the third signaling restriction set, and where the first signaling restriction set corresponds to a first subset of cell DTX/DRX configurations of the plurality of cell DTX/DRX configurations, each cell DTX/DRX configuration of the first subset of cell DTX/DRX configurations being associated with a respective first DTX/DRX cycle including first non-active periods of durations less than or equal to a first non-active duration threshold of the plurality of non-active duration thresholds; the second signaling restriction set corresponds to a second subset of cell DTX/DRX configurations of the plurality of cell DTX/DRX configurations, each cell DTX/DRX configuration of the second subset of cell DTX/DRX configurations being associated with a respective second DTX/DRX cycle including second non-active periods of durations greater than the first non-active duration threshold and less than or equal to a second non-active duration threshold of the plurality of non-active duration thresholds, the second signaling restriction set including a smaller quantity of signaling restrictions relative to the first signaling restriction set; and the third signaling restriction set corresponds to a third subset of cell DTX/DRX configurations of the plurality of cell DTX/DRX configurations, each cell DTX/DRX configuration of the third subset of cell DTX/DRX configurations being associated with a respective third DTX/DRX cycle including third non-active periods of durations greater than the second non-active duration threshold, the third signaling restriction set including a smaller quantity of signaling restrictions relative to the second signaling restriction set.

Aspect 6: The method of any of aspects 1-5, further including: receiving an indication of one or more non-active duration thresholds and one or more active duration thresholds associated with the plurality of signaling restriction sets; and selecting the signaling restriction set in accordance with whether a duration of a non-active period of a DTX/DRX cycle associated with the cell DTX/DRX configuration satisfies one or more of the one or more non-active duration thresholds and in accordance with whether a duration of an active period of the DTX/DRX cycle associated with the cell DTX/DRX configuration satisfies one or more of the one or more active duration thresholds.

Aspect 7: The method of aspect 6, where the plurality of signaling restriction sets includes at least a first signaling restriction set and a second signaling restriction set, and where the first signaling restriction set corresponds to a first subset of cell DTX/DRX configurations of the plurality of cell DTX/DRX configurations, each cell DTX/DRX configuration of the first subset of cell DTX/DRX configurations being associated with a respective first DTX/DRX cycle including first non-active periods of durations less than or equal to a shortest non-active duration threshold of the one or more non-active duration thresholds and first active periods of durations less than or equal to a shortest active duration threshold of the one or more active duration thresholds, the first signaling restriction set including a largest quantity of signaling restrictions; and the second signaling restriction set corresponds to a second subset of cell DTX/DRX configurations of the plurality of cell DTX/DRX configurations, each cell DTX/DRX configuration of the second subset of cell DTX/DRX configurations being associated with a respective second DTX/DRX cycle including second non-active periods of durations greater than a longest non-active duration threshold of the one or more non-active duration thresholds and second active periods of durations greater than a longest active duration threshold of the one or more active duration thresholds, the second signaling restriction set including a smallest quantity of signaling restrictions.

Aspect 8: The method of any of aspects 1-7, further including: receiving the information indicative of the plurality of signaling restriction sets and the information indicative of the plurality of cell DTX/DRX configurations via a same set of one or more control messages, where each signaling restriction set of the plurality of signaling restriction sets is indicated by a respective cell DTX/DRX configuration of the plurality of cell DTX/DRX configurations; and receiving a downlink control information message activating the cell DTX/DRX configuration, where communicating in accordance with the signaling restriction set is in association with the signaling restriction set being indicated by the cell DTX/DRX configuration activated by the downlink control information message.

Aspect 9: The method of any of aspects 1-8, further including: receiving an indication of a mapping between the plurality of cell DTX/DRX configurations and the plurality of signaling restriction sets, where communicating in accordance with the cell DTX/DRX configuration and the signaling restriction set is associated with the mapping.

Aspect 10: The method of any of aspects 1-9, further including: selecting the signaling restriction set in accordance with a criteria, where the criteria includes one or more of a latency tolerance of the UE or a power level of the UE, and where communicating in accordance with the signaling restriction set is in association with selecting the signaling restriction set in accordance with the criteria.

Aspect 11: The method of aspect 10, further including: receiving an indication of the criteria; or retrieving the criteria from a memory of the UE.

Aspect 12: The method of any of aspects 1-11, further including: receiving a downlink control information message activating the cell DTX/DRX configuration, where the downlink control information message includes an indication of the signaling restriction set, and where communicating in accordance with the signaling restriction set is in association with the downlink control information message including the indication of the signaling restriction set.

Aspect 13: The method of aspect 12, where the indication of the signaling restriction set includes a quantity of bits, different permutations of the quantity of bits indicating different signaling restriction sets of the plurality of signaling restriction sets.

Aspect 14: The method of any of aspects 1-13, further including: receiving information indicative of a periodic configuration associated with two or more signaling restriction sets of the plurality of signaling restriction sets; communicating, during one or more first non-active periods of a DTX/DRX cycle associated with the cell DTX/DRX configuration, in accordance with a first signaling restriction set of the plurality of signaling restriction sets according to the periodic configuration; and communicating, during one or more second non-active periods of the DTX/DRX cycle associated with the cell DTX/DRX configuration, in accordance with a second signaling restriction set of the plurality of signaling restriction sets according to the periodic configuration, where the first signaling restriction set and the second signaling restriction set are different.

Aspect 15: The method of any of aspects 1-14, further including: receiving a downlink control information message activating the cell DTX/DRX configuration, where the downlink control information message includes information indicative of whether the UE is expected to operate in accordance with a connected-mode DRX configuration at the UE or the cell DTX/DRX configuration.

Aspect 16: The method of any of aspects 1-15, further including: receiving a downlink control information message activating the cell DTX/DRX configuration, where the downlink control information message includes information indicative of a spatial or power adaptation state associated with the serving cell.

Aspect 17: The method of any of aspects 1-16, further including: transmitting an indication of a capability, of the UE, to support the plurality of signaling restriction sets, where receiving the information indicative of the plurality of signaling restriction sets is in accordance with the capability of the UE.

Aspect 18: The method of any of aspects 1-17, where the one or more first control messages and the one or more second control messages include one or more RRC messages.

Aspect 19: A method for wireless communication by a network entity, including: transmitting, to a UE, one or more first control messages including information indicative of a plurality of DTX/DRX configurations associated with a serving cell, each cell DTX/DRX configuration of the plurality of cell DTX/DRX configurations being associated with a respective DTX/DRX cycle; transmitting one or more second control messages including information indicative of a plurality of signaling restriction sets, each signaling restriction set of the plurality of signaling restriction sets being associated with one or more cell DTX/DRX configurations of the plurality of cell DTX/DRX configurations, each signaling restriction set of the plurality of signaling restriction sets including one or more respective signaling restrictions associated with communication between the UE and the serving cell over one or more non-active periods of the respective DTX/DRX cycle; and communicating with the UE via the serving cell in accordance with a cell DTX/DRX configuration of the plurality of cell DTX/DRX configurations and in accordance with a signaling restriction set of the plurality of signaling restriction sets that is associated with the cell DTX/DRX configuration.

Aspect 20: The method of aspect 19, further including: transmitting an indication of a non-active duration threshold associated with the plurality of signaling restriction sets; and selecting the signaling restriction set in accordance with whether a duration of a non-active period of a DTX/DRX cycle associated with the cell DTX/DRX configuration satisfies the non-active duration threshold.

Aspect 21: The method of aspect 20, where the plurality of signaling restriction sets includes at least a first signaling restriction set and a second signaling restriction set, the signaling restriction set being one of the first signaling restriction set or the second signaling restriction set, and where the first signaling restriction set corresponds to a first subset of cell DTX/DRX configurations of the plurality of cell DTX/DRX configurations, each cell DTX/DRX configuration of the first subset of cell DTX/DRX configurations being associated with a respective first DTX/DRX cycle including first non-active periods of durations greater than the non-active duration threshold; and the second signaling restriction set corresponds to a second subset of cell DTX/DRX configurations of the plurality of cell DTX/DRX configurations each cell DTX/DRX configuration of the second subset of cell DTX/DRX configurations being associated with a respective second DTX/DRX cycle including second non-active periods of durations less than or equal to the non-active duration threshold, the second signaling restriction set including a greater quantity of signaling restrictions relative to the first signaling restriction set.

Aspect 22: The method of any of aspects 19-21, further including: transmitting an indication of a plurality of non-active duration thresholds associated with the plurality of signaling restriction sets; and selecting the signaling restriction set in accordance with whether a duration of a non-active period of a DTX/DRX cycle associated with the cell DTX/DRX cycle satisfies one or more of the plurality of non-active duration thresholds.

Aspect 23: The method of aspect 22, where the plurality of signaling restriction sets includes at least a first signaling restriction set, a second signaling restriction set, and a third signaling restriction set, the signaling restriction set being one of the first signaling restriction set, the second signaling restriction set, or the third signaling restriction set, and where the first signaling restriction set corresponds to a first subset of cell DTX/DRX configurations of the plurality of cell DTX/DRX configurations, each cell DTX/DRX configuration of the first subset of cell DTX/DRX configurations being associated with a respective first DTX/DRX cycle including first non-active periods of durations less than or equal to a first non-active duration threshold of the plurality of non-active duration thresholds; the second signaling restriction set corresponds to a second subset of cell DTX/DRX configurations of the plurality of cell DTX/DRX configurations, each cell DTX/DRX configuration of the second subset of cell DTX/DRX configurations being associated with a respective second DTX/DRX cycle including second non-active periods of durations greater than the first non-active duration threshold and less than or equal to a second non-active duration threshold of the plurality of non-active duration thresholds, the second signaling restriction set including a smaller quantity of signaling restrictions relative to the first signaling restriction set; and the third signaling restriction set corresponds to a third subset of cell DTX/DRX configurations of the plurality of cell DTX/DRX configurations, each cell DTX/DRX configuration of the third subset of cell DTX/DRX configurations being associated with a respective third DTX/DRX cycle including third non-active periods of durations greater than the second non-active duration threshold, the third signaling restriction set including a smaller quantity of signaling restrictions relative to the second signaling restriction set.

Aspect 24: The method of any of aspects 19-23, further including: transmitting an indication of one or more non-active duration thresholds and one or more active duration thresholds associated with the plurality of signaling restriction sets; and selecting the signaling restriction set in accordance with whether a duration of a non-active period of a DTX/DRX cycle associated with the cell DTX/DRX configuration satisfies one or more of the one or more non-active duration thresholds and in accordance with whether a duration of an active period of the DTX/DRX cycle associated with the cell DTX/DRX configuration satisfies one or more of the one or more active duration thresholds.

Aspect 25: The method of aspect 24, where the plurality of signaling restriction sets includes at least a first signaling restriction set and a second signaling restriction set, and where the first signaling restriction set corresponds to a first subset of cell DTX/DRX configurations of the plurality of cell DTX/DRX configurations, each cell DTX/DRX configuration of the first subset of cell DTX/DRX configurations being associated with a respective first DTX/DRX cycle including first non-active periods of durations less than or equal to a shortest non-active duration threshold of the one or more non-active duration thresholds and first active periods of durations less than or equal to a shortest active duration threshold of the one or more active duration thresholds, the first signaling restriction set including a largest quantity of signaling restrictions; and the second signaling restriction set corresponds to a second subset of cell DTX/DRX configurations of the plurality of cell DTX/DRX configurations, each cell DTX/DRX configuration of the second subset of cell DTX/DRX configurations being associated with a respective second DTX/DRX cycle including second non-active periods of durations greater than a longest non-active duration threshold of the one or more non-active duration thresholds and second active periods of durations greater than a longest active duration threshold of the one or more active duration thresholds, the second signaling restriction set including a smallest quantity of signaling restrictions.

Aspect 26: The method of any of aspects 19-25, further including: transmitting the information indicative of the plurality of signaling restriction sets and the information indicative of the plurality of cell DTX/DRX configurations via a same set of one or more control messages, where each signaling restriction set of the plurality of signaling restriction sets is indicated by a respective cell DTX/DRX configuration of the plurality of cell DTX/DRX configurations; and transmitting a downlink control information message activating the cell DTX/DRX configuration, where communicating in accordance with the signaling restriction set is in association with the signaling restriction set being indicated by the cell DTX/DRX configuration activated by the downlink control information message.

Aspect 27: The method of any of aspects 19-26, further including: transmitting an indication of a mapping between the plurality of cell DTX/DRX configurations and the plurality of signaling restriction sets, where communicating in accordance with the cell DTX/DRX configuration and the signaling restriction set is associated with the mapping.

Aspect 28: The method of any of aspects 19-27, further including: transmitting a downlink control information message activating the cell DTX/DRX configuration, where the downlink control information message includes an indication of the signaling restriction set, and where communicating in accordance with the signaling restriction set is in association with the downlink control information message including the indication of the signaling restriction set.

Aspect 29: The method of aspect 28, where the indication of the signaling restriction set includes a quantity of bits, different permutations of the quantity of bits indicating different signaling restriction sets of the plurality of signaling restriction sets.

Aspect 30: The method of any of aspects 19-29, further including: transmitting information indicative of a periodic configuration associated with two or more signaling restriction sets of the plurality of signaling restriction sets; communicating, during one or more first inactive periods of a DTX/DRX cycle associated with the cell DTX/DRX configuration, in accordance with a first signaling restriction set of the plurality of signaling restriction sets according to the periodic configuration; and communicating, during one or more second inactive periods of the DTX/DRX cycle, in accordance with a second signaling restriction set of the plurality of signaling restriction sets according to the periodic configuration, where the first signaling restriction set and the second signaling restriction set are different.

Aspect 31: The method of any of aspects 19-30, further including: transmitting a downlink control information message activating the cell DTX/DRX configuration, where the downlink control information message includes information indicative of whether the UE is expected to operate in accordance with a connected-mode DRX configuration at the UE or the cell DTX/DRX configuration.

Aspect 32: The method of any of aspects 19-31, further including: transmitting a downlink control information message activating the cell DTX/DRX configuration, where the downlink control information message includes information indicative of a spatial or power adaptation state associated with the serving cell.

Aspect 33: The method of any of aspects 19-32, further including: receiving an indication of a capability, of the UE, to support the plurality of signaling restriction sets, where transmitting the information indicative of the plurality of signaling restriction sets is in accordance with the capability of the UE.

Aspect 34: The method of any of aspects 19-33, where the one or more first control messages and the one or more second control messages include one or more RRC messages.

Aspect 35: A UE, including a processing system that includes processor circuitry and memory circuitry that stores code, the processing system configured to cause the UE to perform a method of any of aspects 1-18

Aspect 35: A UE, including one or more memories storing processor-executable code, and one or more processors coupled with the one or more memories and individually or collectively operable to execute the code to cause the UE to perform a method of any of aspects 1-18.

Aspect 36: A UE, including at least one means for performing a method of any of aspects 1-18.

Aspect 37: A non-transitory computer-readable medium storing code for wireless communication, the code including instructions executable by one or more processors to perform a method of any of aspects 1-18.

Aspect 38: A network entity, including a processing system that includes processor circuitry and memory circuitry that stores code, the processing system configured to cause the network entity to perform a method of any of aspects 19-34

Aspect 38: A network entity, including one or more memories storing processor-executable code, and one or more processors coupled with the one or more memories and individually or collectively operable to execute the code to cause the network entity to perform a method of any of aspects 19-34.

Aspect 39: A network entity, including at least one means for performing a method of any of aspects 19-34.

Aspect 40: A non-transitory computer-readable medium storing code for wireless communication, the code including instructions executable by one or more processors to perform a method of any of aspects 19-34.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communication systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (such as a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. In examples in which the functions are implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, in examples in which the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (such as a list of items prefaced by a phrase such as “at least one of” or “one or more of”) indicates an inclusive list such that, for example, a list of at least one of A, B, or C means A or B or C or AB or AC or BC or ABC (A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, in scenarios in which a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. In examples in which just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
a processing system that includes processor circuitry and memory circuitry that stores code, the processing system configured to cause the UE to:
receive one or more first control messages including information indicative of a plurality of cell discontinuous transmission (DTX) or discontinuous reception (DRX) (DTX/DRX) configurations associated with a serving cell, each cell DTX/DRX configuration of the plurality of cell DTX/DRX configurations being associated with a respective DTX/DRX cycle;
receive one or more second control messages including information indicative of a plurality of signaling restriction sets, each signaling restriction set of the plurality of signaling restriction sets being associated with one or more cell DTX/DRX configurations of the plurality of cell DTX/DRX configurations, each signaling restriction set of the plurality of signaling restriction sets including one or more respective signaling restrictions associated with communication between the UE and the serving cell over one or more non-active periods of the respective DTX/DRX cycle; and
communicate with the serving cell in accordance with a cell DTX/DRX configuration of the plurality of cell DTX/DRX configurations and in accordance with a signaling restriction set of the plurality of signaling restriction sets that is associated with the cell DTX/DRX configuration.

2. The UE of claim 1, wherein the processing system is further configured to cause the UE to:
receive an indication of a non-active duration threshold associated with the plurality of signaling restriction sets; and
select the signaling restriction set in accordance with whether a duration of a non-active period of a DTX/DRX cycle associated with the cell DTX/DRX configuration satisfies the non-active duration threshold.

3. The UE of claim 2, wherein the plurality of signaling restriction sets includes at least a first signaling restriction set and a second signaling restriction set, the signaling restriction set being one of the first signaling restriction set or the second signaling restriction set, and wherein:
the first signaling restriction set corresponds to a first subset of cell DTX/DRX configurations of the plurality of cell DTX/DRX configurations, each cell DTX/DRX configuration of the first subset of cell DTX/DRX configurations being associated with a respective first DTX/DRX cycle including first non-active periods of durations greater than the non-active duration threshold; and
the second signaling restriction set corresponds to a second subset of cell DTX/DRX configurations of the plurality of cell DTX/DRX configurations, each cell DTX/DRX configuration of the second subset of cell DTX/DRX configurations being associated with a respective second DTX/DRX cycle including second non-active periods of durations less than or equal to the non-active duration threshold, the second signaling restriction set including a greater quantity of signaling restrictions relative to the first signaling restriction set.

4. The UE of claim 1, wherein the processing system is further configured to cause the UE to:
receive an indication of a plurality of non-active duration thresholds associated with the plurality of signaling restriction sets; and
select the signaling restriction set in accordance with whether a duration of a non-active period of a DTX/DRX cycle associated with the cell DTX/DRX configuration satisfies one or more of the plurality of non-active duration thresholds.

5. The UE of claim 4, wherein the plurality of signaling restriction sets includes at least a first signaling restriction set, a second signaling restriction set, and a third signaling restriction set, the signaling restriction set being one of the first signaling restriction set, the second signaling restriction set, or the third signaling restriction set, and wherein:
the first signaling restriction set corresponds to a first subset of cell DTX/DRX configurations of the plurality of cell DTX/DRX configurations, each cell DTX/DRX configuration of the first subset of cell DTX/DRX configurations being associated with a respective first DTX/DRX cycle including first non-active periods of durations less than or equal to a first non-active duration threshold of the plurality of non-active duration thresholds;
the second signaling restriction set corresponds to a second subset of cell DTX/DRX configurations of the plurality of cell DTX/DRX configurations, each cell DTX/DRX configuration of the second subset of cell DTX/DRX configurations being associated with a respective second DTX/DRX cycle including second non-active periods of durations greater than the first non-active duration threshold and less than or equal to a second non-active duration threshold of the plurality of non-active duration thresholds, the second signaling restriction set including a smaller quantity of signaling restrictions relative to the first signaling restriction set; and
the third signaling restriction set corresponds to a third subset of cell DTX/DRX configurations of the plurality of cell DTX/DRX configurations, each cell DTX/DRX configuration of the third subset of cell DTX/DRX configurations being associated with a respective third DTX/DRX cycle including third non-active periods of durations greater than the second non-active duration threshold, the third signaling restriction set including a smaller quantity of signaling restrictions relative to the second signaling restriction set.

6. The UE of claim 1, wherein the processing system is further configured to cause the UE to:
receive an indication of one or more non-active duration thresholds and one or more active duration thresholds associated with the plurality of signaling restriction sets; and
select the signaling restriction set in accordance with whether a duration of a non-active period of a DTX/DRX cycle associated with the cell DTX/DRX configuration satisfies one or more of the one or more non-active duration thresholds and in accordance with whether a duration of an active period of the DTX/DRX cycle associated with the cell DTX/DRX configuration satisfies one or more of the one or more active duration thresholds.

7. The UE of claim 6, wherein the plurality of signaling restriction sets includes at least a first signaling restriction set and a second signaling restriction set, and wherein:
the first signaling restriction set corresponds to a first subset of cell DTX/DRX configurations of the plurality of cell DTX/DRX configurations, each cell DTX/DRX configuration of the first subset of cell DTX/DRX configurations being associated with a respective first DTX/DRX cycle including first non-active periods of durations less than or equal to a shortest non-active duration threshold of the one or more non-active duration thresholds and first active periods of durations less than or equal to a shortest active duration threshold of the one or more active duration thresholds, the first signaling restriction set including a largest quantity of signaling restrictions; and
the second signaling restriction set corresponds to a second subset of cell DTX/DRX configurations of the plurality of cell DTX/DRX configurations, each cell DTX/DRX configuration of the second subset of cell DTX/DRX configurations being associated with a respective second DTX/DRX cycle including second non-active periods of durations greater than a longest non-active duration threshold of the one or more non-active duration thresholds and second active periods of durations greater than a longest active duration threshold of the one or more active duration thresholds, the second signaling restriction set including a smallest quantity of signaling restrictions.

8. The UE of claim 1, wherein the processing system is further configured to cause the UE to:
receive the information indicative of the plurality of signaling restriction sets and the information indicative of the plurality of cell DTX/DRX configurations via a same set of one or more control messages, wherein each signaling restriction set of the plurality of signaling restriction sets is indicated by a respective cell DTX/DRX configuration of the plurality of cell DTX/DRX configurations; and
receive a downlink control information message activating the cell DTX/DRX configuration, wherein communicating in accordance with the signaling restriction set is in association with the signaling restriction set being indicated by the cell DTX/DRX configuration activated by the downlink control information message.

9. The UE of claim 1, wherein the processing system is further configured to cause the UE to:
receive an indication of a mapping between the plurality of cell DTX/DRX configurations and the plurality of signaling restriction sets, wherein communicating in accordance with the cell DTX/DRX configuration and the signaling restriction set is associated with the mapping.

10. The UE of claim 1, wherein the processing system is further configured to cause the UE to:
select the signaling restriction set in accordance with a criteria, wherein the criteria includes one or more of a latency tolerance of the UE or a power level of the UE, and wherein communicating in accordance with the signaling restriction set is in association with selecting the signaling restriction set in accordance with the criteria.

11. The UE of claim 10, wherein the processing system is further configured to cause the UE to:
receive an indication of the criteria; or
retrieve the criteria from a memory of the UE.

12. The UE of claim 1, wherein the processing system is further configured to cause the UE to:
receive a downlink control information message activating the cell DTX/DRX configuration, wherein the downlink control information message includes an indication of the signaling restriction set, and wherein communicating in accordance with the signaling restriction set is in association with the downlink control information message including the indication of the signaling restriction set.

13. The UE of claim 12, wherein the indication of the signaling restriction set includes a quantity of bits, different permutations of the quantity of bits indicating different signaling restriction sets of the plurality of signaling restriction sets.

14. The UE of claim 1, wherein the processing system is further configured to cause the UE to:
receive information indicative of a periodic configuration associated with two or more signaling restriction sets of the plurality of signaling restriction sets;
communicating, during one or more first non-active periods of a DTX/DRX cycle associate the cell DTX/DRX configuration, in accordance with a first signaling restriction set of the plurality of signaling restriction sets according to the periodic configuration; and
communicating, during one or more second non-active periods of the DTX/DRX cycle associate the cell DTX/DRX configuration, in accordance with a second signaling restriction set of the plurality of signaling restriction sets according to the periodic configuration, wherein the first signaling restriction set and the second signaling restriction set are different.

15. A network entity, comprising:
a processing system that includes processor circuitry and memory circuitry that stores code, the processing system configured to cause the network entity to:
transmit, to a user equipment (UE), one or more first control messages including information indicative of a plurality of discontinuous transmission (DTX) or discontinuous reception (DRX) (DTX/DRX) configurations associated with a serving cell, each cell DTX/DRX configuration of the plurality of cell DTX/DRX configurations being associated with a respective DTX/DRX cycle;
transmit one or more second control messages including information indicative of a plurality of signaling restriction sets, each signaling restriction set of the plurality of signaling restriction sets being associated with one or more cell DTX/DRX configurations of the plurality of cell DTX/DRX configurations, each signaling restriction set of the plurality of signaling restriction sets including one or more respective signaling restrictions associated with communication between the UE and the serving cell over one or more non-active periods of the respective DTX/DRX cycle; and
communicate with the UE via the serving cell in accordance with a cell DTX/DRX configuration of the plurality of cell DTX/DRX configurations and in accordance with a signaling restriction set of the plurality of signaling restriction sets that is associated with the cell DTX/DRX configuration.

16. The network entity of claim 15, wherein the processing system is further configured to cause the network entity to:
transmit an indication of a non-active duration threshold associated with the plurality of signaling restriction sets; and
select the signaling restriction set in accordance with whether a duration of a non-active period of a DTX/DRX cycle associated with the cell DTX/DRX configuration satisfies the non-active duration threshold.

17. The network entity of claim 16, wherein the plurality of signaling restriction sets includes at least a first signaling restriction set and a second signaling restriction set, the signaling restriction set being one of the first signaling restriction set or the second signaling restriction set, and wherein:
the first signaling restriction set corresponds to a first subset of cell DTX/DRX configurations of the plurality of cell DTX/DRX configurations, each cell DTX/DRX configuration of the first subset of cell DTX/DRX configurations being associated with a respective first DTX/DRX cycle including first non-active periods of durations greater than the non-active duration threshold; and
the second signaling restriction set corresponds to a second subset of cell DTX/DRX configurations of the plurality of cell DTX/DRX configurations each cell DTX/DRX configuration of the second subset of cell DTX/DRX configurations being associated with a respective second DTX/DRX cycle including second non-active periods of durations less than or equal to the non-active duration threshold, the second signaling restriction set including a greater quantity of signaling restrictions relative to the first signaling restriction set.

18. The network entity of claim 15, wherein the processing system is further configured to cause the network entity to:
transmit an indication of a plurality of non-active duration thresholds associated with the plurality of signaling restriction sets; and
select the signaling restriction set in accordance with whether a duration of a non-active period of a DTX/DRX cycle associated with the cell DTX/DRX cycle satisfies one or more of the plurality of non-active duration thresholds.

19. The network entity of claim 18, wherein the plurality of signaling restriction sets includes at least a first signaling restriction set, a second signaling restriction set, and a third signaling restriction set, the signaling restriction set being one of the first signaling restriction set, the second signaling restriction set, or the third signaling restriction set, and wherein:
the first signaling restriction set corresponds to a first subset of cell DTX/DRX configurations of the plurality of cell DTX/DRX configurations, each cell DTX/DRX configuration of the first subset of cell DTX/DRX configurations being associated with a respective first DTX/DRX cycle including first non-active periods of durations less than or equal to a first non-active duration threshold of the plurality of non-active duration thresholds;
the second signaling restriction set corresponds to a second subset of cell DTX/DRX configurations of the plurality of cell DTX/DRX configurations, each cell DTX/DRX configuration of the second subset of cell DTX/DRX configurations being associated with a respective second DTX/DRX cycle including second non-active periods of durations greater than the first non-active duration threshold and less than or equal to a second non-active duration threshold of the plurality of non-active duration thresholds, the second signaling restriction set including a smaller quantity of signaling restrictions relative to the first signaling restriction set; and
the third signaling restriction set corresponds to a third subset of cell DTX/DRX configurations of the plurality of cell DTX/DRX configurations, each cell DTX/DRX configuration of the third subset of cell DTX/DRX configurations being associated with a respective third DTX/DRX cycle including third non-active periods of durations greater than the second non-active duration threshold, the third signaling restriction set including a smaller quantity of signaling restrictions relative to the second signaling restriction set.

20. The network entity of claim 15, wherein the processing system is further configured to cause the network entity to:
transmit an indication of one or more non-active duration thresholds and one or more active duration thresholds associated with the plurality of signaling restriction sets; and
select the signaling restriction set in accordance with whether a duration of a non-active period of a DTX/DRX cycle associated with the cell DTX/DRX configuration satisfies one or more of the one or more non-active duration thresholds and in accordance with whether a duration of an active period of the DTX/DRX cycle associated with the cell DTX/DRX configuration satisfies one or more of the one or more active duration thresholds.

21. The network entity of claim 20, wherein the plurality of signaling restriction sets includes at least a first signaling restriction set and a second signaling restriction set, and wherein:
the first signaling restriction set corresponds to a first subset of cell DTX/DRX configurations of the plurality of cell DTX/DRX configurations, each cell DTX/DRX configuration of the first subset of cell DTX/DRX configurations being associated with a respective first DTX/DRX cycle including first non-active periods of durations less than or equal to a shortest non-active duration threshold of the one or more non-active duration thresholds and first active periods of durations less than or equal to a shortest active duration threshold of the one or more active duration thresholds, the first signaling restriction set including a largest quantity of signaling restrictions; and
the second signaling restriction set corresponds to a second subset of cell DTX/DRX configurations of the plurality of cell DTX/DRX configurations, each cell DTX/DRX configuration of the second subset of cell DTX/DRX configurations being associated with a respective second DTX/DRX cycle including second non-active periods of durations greater than a longest non-active duration threshold of the one or more non-active duration thresholds and second active periods of durations greater than a longest active duration threshold of the one or more active duration thresholds, the second signaling restriction set including a smallest quantity of signaling restrictions.

22. The network entity of claim 15, wherein the processing system is further configured to cause the network entity to:
transmit the information indicative of the plurality of signaling restriction sets and the information indicative of the plurality of cell DTX/DRX configurations via a same set of one or more control messages, wherein each signaling restriction set of the plurality of signaling restriction sets is indicated by a respective cell DTX/DRX configuration of the plurality of cell DTX/DRX configurations; and
transmit a downlink control information message activating the cell DTX/DRX configuration, wherein communicating in accordance with the signaling restriction set is in association with the signaling restriction set being indicated by the cell DTX/DRX configuration activated by the downlink control information message.

23. The network entity of claim 15, wherein the processing system is further configured to cause the network entity to:
transmit an indication of a mapping between the plurality of cell DTX/DRX configurations and the plurality of signaling restriction sets, wherein communicating in accordance with the cell DTX/DRX configuration and the signaling restriction set is associated with the mapping.

24. The network entity of claim 15, wherein the processing system is further configured to cause the network entity to:
transmit a downlink control information message activating the cell DTX/DRX configuration, wherein the downlink control information message includes an indication of the signaling restriction set, and wherein communicating in accordance with the signaling restriction set is in association with the downlink control information message including the indication of the signaling restriction set.

25. A method for wireless communication by a user equipment (UE), comprising:
receiving one or more first control messages including information indicative of a plurality of cell discontinuous transmission (DTX) or discontinuous reception (DRX) (DTX/DRX) configurations associated with a serving cell, each cell DTX/DRX configuration of the plurality of cell DTX/DRX configurations being associated with a respective DTX/DRX cycle;
receiving one or more second control messages including information indicative of a plurality of signaling restriction sets, each signaling restriction set of the plurality of signaling restriction sets being associated with one or more cell DTX/DRX configurations of the plurality of cell DTX/DRX configurations, each signaling restriction set of the plurality of signaling restriction sets including one or more respective signaling restrictions associated with communication between the UE and the serving cell over one or more non-active periods of the respective DTX/DRX cycle; and
communicating with the serving cell in accordance with a cell DTX/DRX configuration of the plurality of cell DTX/DRX configurations and in accordance with a signaling restriction set of the plurality of signaling restriction sets that is associated with the cell DTX/DRX configuration.

26. The method of claim 25, further comprising transmitting an indication of a capability, of the UE, to support the plurality of signaling restriction sets, wherein receiving the information indicative of the plurality of signaling restriction sets is in accordance with the capability of the UE.

27. The method of claim 25, wherein the one or more first control messages and the one or more second control messages include one or more radio resource control (RRC) messages.

28. A method for wireless communication by a network entity, comprising:
transmitting, to a user equipment (UE), one or more first control messages including information indicative of a plurality of discontinuous transmission (DTX) or discontinuous reception (DRX) (DTX/DRX) configurations associated with a serving cell, each cell DTX/DRX configuration of the plurality of cell DTX/DRX configurations being associated with a respective DTX/DRX cycle;
transmitting one or more second control messages including information indicative of a plurality of signaling restriction sets, each signaling restriction set of the plurality of signaling restriction sets being associated with one or more cell DTX/DRX configurations of the plurality of cell DTX/DRX configurations, each signaling restriction set of the plurality of signaling restriction sets including one or more respective signaling restrictions associated with communication between the UE and the serving cell over one or more non-active periods of the respective DTX/DRX cycle; and
communicating with the UE via the serving cell in accordance with a cell DTX/DRX configuration of the plurality of cell DTX/DRX configurations and in accordance with a signaling restriction set of the plurality of signaling restriction sets that is associated with the cell DTX/DRX configuration.

29. The method of claim 28, further comprising transmitting a downlink control information message activating the cell DTX/DRX configuration, wherein the downlink control information message includes information indicative of whether the UE is expected to operate in accordance with a connected-mode DRX configuration at the UE or the cell DTX/DRX configuration.

30. The method of claim 28, further comprising transmitting a downlink control information message activating the cell DTX/DRX configuration, wherein the downlink control information message includes information indicative of a spatial or power adaptation state associated with the serving cell.
